(19) United States
(12) Patent Application Publication
(10) Pub. No.: US 2024/0091758 A1
(43) Pub. Date: Mar. 21, 2024

(54) CATALYTIC CAVITATION-INDUCING AGENTS FOR SONOCHEMISTRY

(71) Applicant: OXFORD UNIVERSITY INNOVATION LIMITED, Oxford (GB)

(72) Inventors: James KWAN, Oxford (GB); Qianwenhao FAN, Singapore (SG); Xiaoqian SU, Singapore (SG); Paul Wen LIU, Singapore (SG); Umesh Sai JONNALAGADDA, Singapore (SG); Lakshmi Deepika BHARATULA, Maharashtra (IN)

(21) Appl. No.: 18/039,726

(22) PCT Filed: Dec. 6, 2021
(86) PCT No.: PCT/GB2021/053183

§ 371 Date: Jun. 1, 2023

(30) Foreign Application Priority Data
Dec. 7, 2020 (SG) 10202012186T
Sep. 2, 2021 (SG) 10202109064P

(51) Int. Cl. B01J 37/34; B01J 21/06; B01J 23/52; B01J 37/03

(52) U.S. Cl. CPC B01J 37/343; B01J 21/063; B01J 23/52; B01J 37/031

(57) ABSTRACT

The invention concerns a sonocatalyst which is suitable for promoting a chemical reaction initiated by ultrasound irradiation. The invention also relates to a method of catalysing a reaction by exposing the sonocatalyst to ultrasound. The invention also relates to the use of a sonocatalyst as described herein in a method as described herein. The invention also concerns an apparatus comprising the sonocatalyst of the invention, which may be used to perform a method of the invention

### FIELD OF THE INVENTION

The invention relates to a sonocatalyst which is suitable for promoting a chemical reaction initiated by ultrasound irradiation. The sonocatalyst comprises one or more nanoparticles, each of which has a structure capable of trapping gas and which functions as a catalyst. The invention also relates to a method of catalysing a reaction by exposing the sonocatalyst to ultrasound. The invention also relates to the use of a sonocatalyst as described herein in a method as described herein. The invention also concerns an apparatus comprising the sonocatalyst of the invention, which may be used to perform a method of the invention.

### BACKGROUND TO THE INVENTION

Recently, ultrasound has attracted attention as a green process to enable and enhance catalytic processes [9-11]. The operating principle of ultrasound-mediated catalysis (sonocatalysis) is acoustic cavitation [11, 12], a phenomenon that describes the oscillatory motion of a gas or vapour bubble in an acoustic field. The term “acoustic cavitation” also refers to the formation or nucleation of such bubbles. At low acoustic intensities, bubbles tend to undergo stable oscillations, resulting in local streaming changes in environment that can improve material dispersion, collision between chemicals, and absorption-desorption process [13]. With larger acoustic intensities, the oscillations become more asymmetric and result in the uncontrolled expansion and eventual inertial collapse of the bubble, which is often referred to as inertial cavitation. This inertial collapse of the bubble generates localized intense temperatures and pressures [14], which in turn generates light (sonoluminescence) [15], free radicals [16], and local heating [17]. The local physicochemical changes from inertial cavitation accelerates chemical reactions under bulk ambient conditions.

Inertial cavitation is often attributed as the main driving force to facilitate sonochemical reactions.(1, 2) For inertial cavitation to occur, ultrasonic waves in the fluid medium nucleate gas or vapor cavities to further undergo oscillations that can ultimately lead to bubble collapse at high acoustic intensities.(1-3) These collapse events create short-lived local regions of extreme temperatures and pressures, (4) generating light—referred to as sonoluminescence—and reactive chemical species (e.g., free radicals, singlet oxygen, etc.).(3, 5) The use of ultrasound to generate these transient, high energy events is distinct from conventional synthetic chemistry methods and has allowed for the development of unique materials under ambient conditions.(6, 7) Thus, sonochemistry has shown potential in a broad spectrum of applications including green polymer synthesis,(8) waste water treatment,(9) and biomedical therapies.(10-12) Additionally, cavitation has been established to further enhance electrochemistry, thereby facilitating controlled transduction of other stimulus-triggered pathways for catalysis.

As nucleating cavitation is a stochastic process, conventional sonochemical methods utilize continuous wave ultrasound for extended periods of time to ensure sufficient generation of radicals to move the reaction forward. Prolonging ultrasound exposure time, however, is energetically costly and may lead to secondary effects (2) and side reactions.(8) For instance, low frequency ultrasound (20-100 kHz) may promote polymer chain growth, but as reaction time increases it has also been shown to promote polymer degradation.(8) Higher frequency ultrasound (>200 kHz) may circumvent polymer degradation. However, these acoustic waves are more readily absorbed by the fluid, leading to greater changes in fluid temperature that may influence the chemical reaction.(13) Extending ultrasound exposure times therefore may not lead to efficient product yield, and therefore alternative approaches to enhancing the sonochemical effect are under investigation.

Moreover, as cavitation in a homogeneous fluid is a stochastic process, its inception requires immense acoustic energy, thereby making the process difficult to control and energetically costly for chemical processing [18, 19]. To circumvent the high energy thresholds in homogenous fluids, the addition of exogenous gas nuclei reduces the energy required for cavitation and increases the rate of formation of cavitation bubbles [20-23]. Micron-sized gaseous particles (i.e., microbubbles) have been used as cavitation agents to promote sonoluminescence at low acoustic intensities to activate photosensitisers and generate

reactive oxygen species (ROS)[24]. However, this still does not address an underlying challenge with catalytic sonochemistry, which is the spatial decoupling between the cavitation events and the catalyst/sensitizers.

To amplify the sonochemical effects of cavitation, photosensitizers such as photosensitive semiconductors,(5, 14-21) graphene,(17, 22, 23) or polymers (24, 25) utilize stochastic inception cavitation of the nearby fluid from high acoustic intensities (10, 26, 27) to create sonoluminescence. This light emission interacts with the photosensitizers to generate reactive oxygen species (ROS). Further enhancements by modifying the photosensitizers (22, 27, 28), adding hydrogen peroxide (H₂O₂), or including other stimuli (e.g. light) into the reaction solution have been done (29, 30); however, these methods lack spatiotemporal control of cavitation events as they rely on continuous wave ultrasound to nucleate cavitation. In order to control cavitation events at lower acoustic thresholds, exogenous gas bubbles are introduced into solution to function as cavitation nuclei (i.e., cavitation agents). These cavitation agents have been used in conjunction with photosensitizers recently to allow ROS generation with pulsed ultrasound(24); however, due to the limited fluence of sonoluminescence,(31, 32) this sonochemical method requires cavitation to occur nearby the photosensitizer to maximize light interaction.

As this spatial decoupling of inertial cavitation events from photocatalytic sites is a key limitation for heterogenous sonochemistry, it is desirable to control cavitation at photocatalytic sites to improve the rate kinetics of sonochemical reactions.

Despite the established literature on sonocatalysis, there no discussion of catalytic agents capable of nucleating cavitation for more efficient sonochemistry

Gold nanoparticles (AuNPs) have emerged as a potential catalyst with unique catalytic properties [1-3]. Generally, in order for gold to be utilized as an effective catalyst under ambient conditions, the particle cluster size must be less than 5 nm [4]. Single Au atoms, bilayers, sub-nanometre clusters, clusters (1-2 nm), and nanoparticles (2-5 nm) have been proposed as the active sizes of the Au species depending on the type of support [5]. Because of their high surface energy, small Au catalyst are highly mobile and tend to aggregate during synthetic and catalytic processes. Therefore, fabrication of Au catalysts is often marred by complex doping methods to underlying support structures (e.g., TiO₂, ZnO, etc) to enhance the native capabilities of the structure. This doping strategy is often accompanied by challenges with controlling the precise shape of the deposited gold clusters, rapid deactivation, and difficulties in catalyst recovery[5-7]. Though larger (>100 nm in diameter) Au particles are more amenable production, filtration, and recovery, these particles lack the requisite catalytic properties under ambient conditions[8].

### SUMMARY OF THE INVENTION

The invention concerns a class of acoustically responsive nanoparticles that allow for rapid generation of reactive species (such as reactive radical species) under ultrasound (such as pulsed ultrasonic irradiation). These nanoparticles have potential applications in healthcare and chemical processing.

These nanoparticles, and methods of using the nanoparticles, have advantages over existing sonochemical methods. Sonochemical processing offers a unique avenue for sustainable chemistry. Currently, methods utilize continuous wave ultrasound to trigger cavitation events in heterogenous solutions containing catalysts (which may be referred to as sonocatalysts when present in an acoustic field) to enhance radical generation from ultrasound. Unfortunately, these methods lack spatial control, so a given cavitation event may not be proximal to the catalyst, thereby lowering the efficiency of the system. The present technology provides an improvement to the current state of the art by creating a gas-stabilizing sonocatalyst (e.g. a sonophotocatalyst). This key feature permits cavitation to occur at lower intensities using pulsed ultrasound, thereby reducing the operational energy requirement for cavitation to occur. Furthermore, by coupling the gas bubble to the catalyst, the cavitation event is localized to the reaction site, removing the spatial control limitation that exists in current methods. The particles described herein are also not destroyed during ultrasound irradiation and sustain cavitation for several minutes. Therefore, these particles have an advantage of rapid radical production for chemical processing with possible reusability for subsequent reactions.

Accordingly, the invention provides a sonocatalyst, comprising a nanoparticle which has a structure capable of trapping gas and which functions as a catalyst. The material or materials from which the nanoparticle is made is/are selected for their catalytic properties, so that they may catalyse a chemical reaction of interest.

When moved from a gaseous environment to a liquid environment, the nanoparticle traps a gas bubble. When the nanoparticle and gas bubble are exposed to ultrasound, the gas bubble expands during the rarefactional ultrasound phase until the compression phase of the ultrasound wave combined with external momentum of the liquid causes the bubble to collapse, i.e., inertial cavitation. This collapse generates reactive species (for example reactive oxygen species such as hydroxyl radicals or singlet oxygen) in the vicinity of the nanoparticle. Consequently, reactions of any chemical reagents in the vicinity can be initiated near to the catalytic nanoparticle. This can lead to an increase in reaction rate, and localisation of any reactions of interest. Thus, the invention provides a method of catalysing a chemical reaction, the method comprising:
(i) providing a sonocatalyst; and
(ii) exposing the sonocatalyst to ultrasound.

More generally, the invention provides the use of a sonocatalyst to catalyse a chemical reaction. Preferably wherein the sonocatalyst is as defined herein. Typically, the sonocatalyst is used in a method as described herein.

The sonocatalyst can be used in a method or use as described herein when exposed to ultrasound. Any apparatus capable of producing ultrasound radiation may be used to generate the ultrasound radiation. Accordingly, the invention provides an apparatus for catalysing a chemical reaction, the apparatus comprising an ultrasound waveform generator and a sonocatalyst as described herein.

In a preferred embodiment, the nanoparticle of the sonocatalyst comprises a material which promotes reactivity by interacting with a chemical reagent involved in the chemical reaction of interest. For instance, the catalyst may stabilise an intermediate (for instance by adsorbing an intermediate such as a hydroxyl radical or proton) or may assist in the formation of such an intermediate. A particularly preferred class of such catalytic materials are photocatalytic materials, which are known to promote a wide variety of decomposition reactions when exposed to electromagnetic radiation (particularly UV and visible light). One example is titania, which is known to produce hydroxyl radicals when exposed to UV light in the presence of water.

Thus, herein is also described the synthesis of gas-trapping nanoparticles that function as both the source for cavitation and catalysis (by both pyrolysis and photocatalysis) thereby creating a sonophotocatalyst. In the description below, TiO₂ fractured nanoshells (TFNs) will be used as an example for such a sonophotocatalyst. Additionally, by entrapping gas onto an electrochemical catalyst, the electron transfer for redox reactions can further be enhanced.

Examples of electrochemical catalysts include platinum and gold. Accordingly, further examples provided include catalytic gold nanoparticles.

The sonocatalytic nanoparticles of the invention have the following novel features:
Construction of particles to permit gas-entrapment to reduce the threshold to nucleate cavitation, thus operational energy requires for chemical processing.
Construction of particles for colocalization of cavitation event to photocatalyst site.
Structure is tunable based on underlying template used.
Potential for reusability as particles not consumed during ultrasound irradiation.
Cavitation sustained over minutes
Functions as radical initiator to minimize additives (e.g. hydrogen peroxide and light irradiation) required for chemical processing
Potential to function as a support structure for enhanced catalysis of other chemical processes, including, but not limited to, advanced oxidative processes and selective oxidation.

These advantages are discussed below.

The sonocatalyst comprises a nanoparticle whose structure permits gas-entrapment. This reduces the acoustic energy threshold for inertial cavitation by providing exogenous gas nuclei that readily respond to the acoustic field, which reduces the energy needed to initiate sonochemical reactions. In some embodiments, therefore, the nanoparticle's structure permits gas-entrapment to promote nucleate cavitation. Similarly, in some embodiments, the method described herein employs the sonocatalyst of the invention to reduce the threshold to nucleate cavitation. Further, in some embodiments the method involves reducing the threshold energy needed to initiate a chemical reaction.

The effect of providing a nucleus at which cavitation can readily occur at a catalytic site is to generate reactive species (by inertial cavitation) at the surface of the catalytic material present in the nanoparticle. In some embodiments, therefore, the method of the invention comprises generating reactive species (typically by inertial cavitation) at the site of the nanoparticle. The combination of initiating a chemical reaction using ultrasound, and promoting that chemical reaction or a related reaction in situ using a catalyst, can lead to advantageously high reaction rates.

Moreover, as the sonocatalyst can be located at a precise position, the location of reaction within a sample can be controlled. Further, the sonocatalyst of the present invention can generate inertial cavitation processes when exposed to pulsed ultrasound, and particularly pulsed ultrasound that is focussed to locally increase the acoustic intensity. This provides a further means for spatial control of the chemistry of interest. Thus, in a particularly preferred embodiment, the method of the invention may comprise providing the sonocatalyst at a pre-determined location. In a further preferred embodiment, the method of the invention may comprise exposing the sonocatalyst to focussed ultrasound radiation, particularly preferably focussed pulsed ultrasound radiation.

The sonocatalyst comprises a nanoparticle whose structure can be adjusted using a template during the synthesis step. The principle is demonstrated herein using titania nanoparticles generated using a spherical template. Thus, in some embodiments the sonocatalyst comprises a nanoparticle having a structure obtainable (e.g. obtained or synthesised) using a template. For instance, the sonocatalyst may comprise a nanoparticle having a structure generated using a spherical template, particularly a nanoscale spherical template. Similarly, in some embodiments the method of the invention comprises generating a sonocatalyst comprising a nanoparticle using a template, for instance a spherical template, particularly a nanoscale spherical template.

One major advantage of the sonocatalyst of the invention is that it is generally robust and is not destroyed by the reaction. Accordingly, it can be re-used. Alternatively or additionally, the catalyst can be used for a reaction lasting some time. In some embodiments, therefore, the method of the invention comprises exposing the sonocatalyst to ultrasound for a period of at least ten seconds, typically for at least one minute, for example for two or more minutes. Where the ultrasound is pulsed ultrasound, the method may comprise exposing the sonocatalyst to pulsed ultrasound for a period of at least ten seconds, typically for at least one minute, for example for two or more minutes.

Similarly, in some embodiments the method of the invention may comprise recovering the sonocatalyst. The method may optionally further comprise washing the recovered sonocatalyst, and/or drying the sonocatalyst. The method may optionally further comprise re-using the sonocatalyst in a further method as described herein.

The sonocatalyst of the invention functions as a generator of reactive species. For instance, in some embodiments the sonocatalyst of the invention functions as a radical generator. This reduces the need to add reaction-promoting additives (such as radical initiators) to promote reaction. In some embodiments, therefore, the method of the invention comprises generating reactive species, preferably radicals. For instance, the step of exposing the sonocatalyst to ultrasound may involve forming reactive species such as radicals. In some embodiments, the method is performed in the absence of radical initiators.

The sonocatalyst described herein is particularly suited to promoting oxidation chemistry, for instance where it may be desirable to generate rapid reaction rates to remove an unwanted species. Accordingly, in some embodiments the sonocatalyst is capable of catalysing an oxidation reaction. For example, the sonocatalyst may promote advanced oxidative processes and/or selective oxidation. Similarly, in some embodiments the method of the invention is a method of catalysing an oxidation reaction, such as an advanced oxidative process and/or a selective oxidation process.

In a particularly preferred embodiment, the invention is described as the following:
1. Submicron-sized solid particle with a surface cavity laden shell structure.
2. The structure is capable of trapping gas to reduce the threshold to nucleate cavitation
3. The resulting particle is capable of generating multiple reactive chemical species (e.g., reactive oxygen species) upon exposure to ultrasound at frequencies above 100 kHz.

In one embodiment, the sonocatalyst may comprise a nanoparticle which comprises a gold nanoparticle having an approximately conical structure capable of trapping gas. The gold nanoparticle's nano-dimensions allow it to act as a catalyst. Thus, herein is also described the potential of gas-trapping cone shaped gold nanoparticles (gs-AuNCs) as dual-modal cavitation nuclei and sonocatalyst, henceforth referred to as sonocatalytic cavitation agents. In the description below, unsupported gold nanocones (AuNCs) were fabricated with a well-defined submicron-scale conical “dendritic” structures with nano-scale multiple-branched petals. The surface cavities of AuNCs trap gas in the cavity. These surface-stabilised nanobubbles cavitate upon exposure to ultrasound. By having cavitation events on catalytic sites, the electron transfer for redox reactions can further be enhanced.

The sonocatalytic gold nanoparticles of the invention have the following novel features:
Construction of nanostructured particles to permit gas-entrapment to reduce the threshold to nucleate cavitation, thus operational energy requires for chemical processing.
Construction of particles for colocalization of cavitation event to catalytic site.
Potential for reusability as particles not consumed during ultrasound irradiation.
Cavitation sustained over minutes
Cavitation-enhanced electron transfer for redox reactions in aqueous media.

Thus, in another embodiment, the sonocatalyst described herein is suited to promoting reduction chemistry, particularly where the nanoparticle comprises an electrochemical catalyst such as a metal. Thus, in some embodiments, the method of catalysing a chemical reaction described herein is a method of catalysing a redox chemical reaction. Preferably, the method is performed in a liquid medium, particularly preferably in an aqueous medium.

The finding that gold nanoparticles were able to act as sonocatalytic was particularly surprising. Gold nanoparticles offer flexible utility in biomedical and chemical applications, but their catalytic activity in ambient conditions has long been discussed as size dependent, where the effective catalyst size has been reported to be less than 5 nm. Unfortunately, smaller particle sizes make recovery difficult. To circumvent these limitations, the inventors provided nanostructured gold particles to entrap gas bubbles in order to respond to ultrasound. In doing so, while the particles have an approximate size of 140-200 nm, cavitation events on the gold surface allows for enhanced catalytic function. The larger size of the particles further makes filtration and recovery easier relative to smaller particles, thereby permitting the particles to be recyclable for subsequent reactions.

In another particularly preferred embodiment, the invention is described as the following:
1. Submicron-sized solid particle with a cone-shape.
2. The structure is capable of trapping gas to reduce the pressure threshold to nucleate cavitation.
3. The resulting particle is capable of facilitating redox reactions on ultrasonic irradiation.

### BRIEF DESCRIPTION OF THE FIGURES

FIG. 1: Crystal and morphological structure of particles before and after calcination. (A) XRD spectra of polystyrene particles (blue curve at bottom, “uncoated beads”), TFNs particles before (orange curve in middle “TiOH-coated beads”), and after calcination (green curve at top, “TFNs”). It is only after calcination that the titanium precursor crystalizes to anatase. Prior to calcination, the particles assume an amorphous structure. The surface morphology and internal structure of the particles before calcination were assessed by SEM and TEM. (B) Prior to calcination, the particles assume a solid and uniform structure with a rough surface. By TEM, it was confirmed that this surface texture is due to the titanium precursor coating the surface of the polystyrene beads, which forms more uniformly from (C) 30 minutes to (D) 2 hours.

FIG. 2: Morphological and crystal characterization of TFNs particles. (A) The TiO₂ polymorph structure was determined by XRD. The resulting spectra was indicative of anatase structure. (B) Following this, the nanoparticle morphology was characterized by TEM imaging, where it was observed that the particles expressed a dark rim staining indicative of a hollow structure and that the particle surface was non-uniform. (C) SEM imaging shows that the particle surfaces have a rough and “porous” morphology. Additionally, the particles assumed a mixture of fully formed, porous, and broken shell morphology. (D) By higher magnification TEM, the fractured shell morphology of the TFNs is outlined in red and gaps in the nanoshell can be can further be observed as lighter pixel intensity spots. Scale bars are 100 nm for all images.

FIG. 3: Schematic diagram of cavitation response setup. A microchannel set in an agarose gel phantom is set to the acoustic focus using a 3D positioning stage. A custom Labview program automates the acoustic burst transmission from the function generator to the HIFU transducer while a syringe pump perfuses TFNs through the agarose phantom. The cavitation response within the tank is picked up by the passive cavitation detector (PCD), which is then amplified before displaying the response profile on the oscilloscope and storing onto the PC.

FIG. 4: Cavitation potential of TFNs at various acoustic pressures. Cavitation potential of the TFNs particles was assessed using a voltage ramp at from (A) 0.5-8.0 MPa using a 1.1 MHz HIFU transducer and (B) 0.2-3.9 MPa using a 0.5 MHz transducer. The cavitation threshold was defined as the pressure at which the probability was 50%. The table inset in (A) and (B) describes the mean cavitation threshold for each sample. (C) As the particles were excited above the cavitation threshold, the power spectral density curve expressed greater evidence of broadband cavitation at both frequencies. Comparatively, the as cavitation was not as prominent for both the degassed TFNs and water only samples, the spectral curves did not present as strong broadband signals. (for A and B n=3, μ±σ)

FIG. 5: Rate kinetics for MB photodegradation of TFNs particles. (A) Photocatalytic degradation of methylene blue probe was assessed over 30 minutes with or without TFNs in solution from which the first order rate kinetics were assessed in (B) for the total light irradiation time. A tabulated summary of MB degradation rates is given in as an inset in (B). (n=3, μ±σ).

FIG. 6: Schematic diagram of experimental setup. The working solution is contained in an acoustically transparent chamber under static flow conditions with the acoustic focus set to the centre of the chamber using a 3D positioning stage. A custom Labview program automates the acoustic burst transmission from the function generator to the HIFU transducer. The cavitation response within the tank is picked up by the passive cavitation detector (PCD), which is then amplified before displaying the response profile on the oscilloscope and storing onto the PC.

FIG. 7: Rate kinetics for MB sonodegradation of TFNs particles. Sonocatalytic degradation of MB was performed over 15 minutes of irradiation at (A) 1.1 MHz and (B) 0.5 MHz. Given the use of pulsed ultrasound, the first order rate kinetics was calculated over the ultrasound exposure time (33% total irradiation time) over the first three minutes of ultrasound irradiation at (C) 1.1 MHz and (D) 0.5 MHz due to the plateau observed with later irradiation times. A tabulated summary of MB degradation rates at different stimuli and ultrasound frequencies is given in below the rate kinetics plots. (n=3, μ±σ).

FIG. 8: Rate kinetics for sonophotocatalytic degradation of MB by total irradiation time. MB degradation by ultrasound correlated to the total experiment time for the first 3 minutes of irradiation at (A) 1.1 MHz and (B) 0.5 MHz. (n=3, μ±σ).

FIG. 9: Morphology of TFNs before and after HIFU. The morphology of the particles before and after HIFU irradiation was assessed by SEM (A and B, respectively). All scale bars are 100 nm.

FIG. 10: MB degradation correlated to total received cavitation energy. For the first 3 minutes of ultrasound irradiation, the cavitation energy received was quantified and correlated to the corresponding moles of MB remaining in solution. (A) At irradiation with 1.1 MHz and (B) 0.5 MHz, it was observed that MB degraded proportionally to cavitation generated and this was accelerated by irradiation of the TFNs particles. On inspection of the power spectral density curves (Ci-iii, Di-iii), it can be seen that cavitation is more clearly sustained over longer exposure times with the TFNs compared to the degassed and no TFNs groups, leading to greater decolorization of the probe.

FIG. 11: Sonophotocatalytic Dynamics of DPBF. (A) DPBF degradation by ultrasound at 1.1 MHz following irradiation for 0, 0.5 1.0, and 1.5 minutes. With TFNs and ultrasound, DPBF absorbance was fully reduced. Comparatively, all other conditions were observed to have a minimal effect on DPBF degradation with increasing time, indicating negligible ROS formation. Data points connected by lines to better visualize the degradation. The rate kinetics of DPBF degradation based on (B) total irradiation time and the (C) ultrasound on-time were then calculated, with the rate constant provided in the inset tables. (D) For all measured time points, the cavitation energy received was quantified and correlated to the corresponding moles of DPBF remaining in solution. It was observed that DPBF degraded exponentially to cavitation and this was accelerated by irradiation of the TFNs particles. (n =3, μ±σ).

FIG. 12: Sonogelation of PEG700-dA. (A) Ultrasonic irradiation of TFNs-laden solution of 20 wt % PEG700-diacrylate resulted in gel coating of particles. (B) Macroscopic images of particles after irradiation shows TFNs agglomerating as gel forms around the particles. (C) Without irradiation, however, TFNs do not develop a gel coating.

FIG. 13: Structural polymorph analysis of Au/Pd@TFNs. (A) TFNs polymorph was characterized by XRD. No discernible differences were observed between TFNs and Au/Pd@TFNs.

FIG. 14: Morphological analysis by TEM. The particle morphology and surface characteristics were validated by TEM, where both (A) TFNs and (B) Au/Pd@TFNs were observed to have a similar hollow shell structure. Au/Pd@TFNs were further found to have darker nanodots randomly dispersed throughout the structure, indicative of Au/Pd loading.

FIG. 15: Cavitation potential of Au/Pd@TFNs at various acoustic pressures. Acoustic Response of the Au/Pd@TFNs particles was assessed using a voltage ramp at from (A) 0.5-8.0 MPa using a 1.1 MHz HIFU transducer and compared to unloaded TFNs and degassed Au/Pd@TFNs. The cavitation threshold was defined as the pressure at which the probability was 50%. The table in (B) describes the cavitation threshold for each sample. (C) As the particles were excited above the cavitation threshold, the power spectral density curve expressed greater evidence of broadband cavitation at both frequencies. Comparatively, the as cavitation was not as prominent for both the degassed samples, the spectral curves did not present as strong broadband signals.

FIG. 16: Concentration test of Au/Pd@TFNs for selective oxidation. Benzyl alcohol conversion to benzaldehyde over 10 minutes ultrasound irradiation using Au/Pd@TFNs at 0-1.5 mg/mL concentration. (n=3, μ±SEM, *P<0.05)

FIG. 17: Validation of Au/Pd modification for selective oxidation. Benzyl alcohol conversion to benzaldehyde over 10 minutes ultrasound irradiation using Au/Pd@TFNs and unloaded TFNs at 1.5 mg/mL. Degassed Au/Pd@TFNs and no particles (BA stock) used as controls to validate differences in benzaldehyde yield. (n=3, μ±SEM, *P<0.05)

FIG. 18: TEM (a-d) and high resolution TEM (inset of d) images, bottom view (b), side view (c), and edges (d) of AuNCs. (e) XRD pattern of AuNCs. (f) UV-vis absorbance spectra of AuNCs. (g) Size measurements of AuNCs before and after lyophilization. The inset shows a photograph of lyophilized AuNCs. Scale bars present 100 nm in (a—c), 10 nm in (d) and 1 nm in (inset of d).

FIG. 19: Acoustic setup. (a) Schematic of the ultrasound setup. (b) Continues flow sample chamber. (c) static flow sample chamber.

FIG. 20: Cavitation potential of AuNCs at different pressures. (a) probability of Cavitation of DI water, AuNCs, and gs-AuNCs with increasing peak negative pressure amplitude from 0.2 to 5.2 MPa. (b) The normalized spectral density curves for gs-AuNCs with increasing peak negative pressure amplitude from below cavitation threshold (1.5 MPa, top), at cavitation threshold (1.8 MPa), above cavitation threshold (2.5 MPa), and at maximum tested pressure (bottom, 5.2 MPa). (c) Cavitation intensity across 10 min of ultrasound exposure.

FIG. 21: Probability of Cavitation of DI water, AuNCs, and gs-AuNCs at a concentration of 0.1 mg/ml with increasing peak negative pressure amplitude from 0.2 to 5.2 MPa.

FIG. 22: Probability of Cavitation of gs-AuNCs at a concentration of 0, 0.01, 0.05, 0.1 and 1 mg/ml with increasing peak negative pressure amplitude from 0.2 to 5.2 MPa.

FIG. 23: UV-vis spectral changes during the sonocatalytic degradation of 4-nitrophenol (4NP) (a) and methylene blue (b) against the reaction time.

FIG. 24: (a) Sonocatalytic degradation of 4-nitriphenol and methylene blue. 4-nitrophenol degradation (a) and quantified rate kinetics (c) at different conditions. Methylene blue degradation (b) and quantified rate kinetics (d) at different conditions. Data represented as mean±SD (n=3).

FIG. 25: gs-AuNCs cavitation dynamics correlation to sonocatalytic reaction kinetics and the recyclability of gs-AuNCs. (a) Acoustic intensities change over time during sonochemical reactions. Sonocatalytic degradation of 4-NP (b) and MB (c) correlated to total received cavitation energy. Data represented as mean±SD (n=3). (d) The recycling stability of gs-AuNCs for catalytic degradation of MB.

FIG. 26: The effect of the NaBH₄ dosage on sonocatalytic degradation of MB.

FIG. 27: The effect of the gs-AuNCs concentration on sonocatalytic degradation of MB.

FIG. 28: Schematic illustration of gas trapping by AuNCs and generation of cavitation event by ultrasound exposure. Upon bubble collapse, hot pot generated and sonolysis of water incurs to generate H+ and hydroxyl radicals. Sonoluminescence is also generated by the cavitation event, which will enhance electron transfer along the gold surface synergistically with the borohydride ions for more efficient reduction kinetics.

### DETAILED DESCRIPTION OF THE INVENTION

Described herein are a sonocatalyst, a method of catalysing a reaction using a sonocatalyst; a use of a sonocatalyst, and an apparatus containing a sonocatalyst which can be used to perform a method as described herein. These aspects of the invention all utilise a sonocatalyst as described herein, and the methods and uses described may involve the same steps. Accordingly, disclosure concerning one aspect of the invention should be understood to relate to the other aspects of the invention also. For instance, disclosure concerning the sonocatalyst of the invention should be understood to relate to the sonocatalyst as used in the methods, uses and apparatus of the invention also.

### Structure of the Nanoparticle(s)

The invention concerns a sonocatalyst, comprising a nanoparticle which has a structure capable of trapping gas and which functions as a catalyst. The specific structure is not particularly limited, but must comprise at least one portion which is capable of trapping gas.

A structure which is capable of trapping gas is generally one which comprises a partially enclosed portion. When placed in a gaseous medium, gas may enter the partially enclosed portion of the nanoparticles's structure. When placed in a liquid medium, gas can remain trapped in the partially enclosed portion.

A structure having a partially enclosed portion is one which contains an empty space situated at least partially within the nanoparticle. That is, the partially enclosed portion is one which is bounded along at least two perpendicular directions by the nanoparticle, but which is not fully enclosed inside the nanoparticle. Thus, the partially enclosed portion is located at an external surface of the nanoparticle.

A partially enclosed portion may be described as a hollow, or a cavity. In one embodiment therefore, the nanoparticle may be said to comprise one or more cavities.

The nanoparticle may comprise one or more partially enclosed portions. For instance, the nanoparticle may comprise one or more cavities. In some embodiments, the nanoparticle may have a structure comprising a single partially enclosed portion, i.e. a single cavity.

A suitable structure for trapping gas is a concave region present at an external surface of the nanoparticle. Thus, the nanoparticle's structure may comprise one or more concave regions at an external surface of the nanoparticle.

One suitable shape for a partially enclosed portion in the nanoparticle's structure is a sphere. Thus, in some embodiments the nanoparticle may comprise a cavity at its external surface which has a shape corresponding approximately to a part of a sphere. For instance, the nanoparticle may comprise a cavity at its external surface having a shape corresponding to a part of a sphere. The sphere is typically a sphere having a radius of 1 to 1000 nm, preferably 10 to 500 nm, more preferably 20 to 250 nm, most preferably 50 to 200 nm.

Another suitable shape for a partially enclosed portion in the nanoparticle's structure is a cone. Thus, in some embodiments the nanoparticle may comprise a cavity at its external surface which has an approximately conical shape, such as a conical shape. The cone is typically a cone having a base radius of 1 to 1000 nm, preferably 10 to 500 nm, more preferably 20 to 250 nm, most preferably 50 to 200 nm.

The structure of the nanoparticle may be a shell structure, comprising or consisting of a shell of material surrounding a cavity (such as a part-sphere or conical cavity as described above). In such cases, the nanoparticle may be described as a “nanoshell”. The entirety of its structure constitutes a shell around a partially enclosed region suitable for trapping gas. Where the nanoparticle has a nanoshell structure, the thickness of the shell is typically less than 100 nm thick, for instance less than 50 nm thick, preferably less than 25 nm thick.

In order to facilitate the trapping of gas, the partially enclosed region is located at an external surface of the nanoparticle such that gas may enter the partially enclosed region. However, as will be discussed in more detail below, it can be convenient to manufacture suitable nanoparticles by depositing material on a template, thus producing nanoparticles containing a fully enclosed region. In order to remove the template and produce a nanoparticle with a structure containing a cavity at an external surface of the nanoparticle, it may be necessary to break the initially-produced nanoparticles to expose the cavity within. This process can produce a nanoparticle with a structure based on a shell around the template, which is broken or “fractured” to expose the cavity within. Such structures are referred to as fractured nanoshell structures. In some embodiments of the sonocatalyst, therefore, the nanoparticle comprises a fractured nanoshell structure.

In a particularly preferred example, the catalyst comprises an approximately spherical or spherical nanoshell structure.

Another suitable method of formulating a nanoparticle having a structure capable of trapping gas is to grow a dendritic structure. A dendritic structure comprises a plurality of strands or dendrites which create a partially enclosed region therebetween. In some embodiments, therefore, the nanoparticle comprises a dendritic structure. The dendrites typically have a smallest diameter of less than 100 nm, preferably less than 50 nm, for instance less than 25 nm or less than 10 nm. generally, the smallest diameter of the dendrites is at least 1 nm.

The dendrites may be arranged in any orientation relative to one another. For instance, they may be arranged so as to provide a hollow cavity therebetween which is approximately spherical or approximately conical. Preferably, the dendrites are arranged so as to form a hollow cavity therebetween having an approximately conical shape. The approximately conical shape typically has a base radius of from about 1 nm to 100 nm, preferably 10 to 500 nm, more preferably 20 to 250 nm, most preferably 50 to 200 nm.

The structure of a nanoparticle may be determined by any suitable method such as TEM or STEM.

It is the size of the cavity, rather than the size of the nanoparticle, which is of particular importance for acoustic chemistry, because the size and structure of the cavity determine the size of the trapped gas bubble. If the trapped gas bubble is too large, it will not absorb energy when irradiated with ultrasound but will rather reflect the ultrasound radiation. On the other hand, if the bubble is small, it may take an excessive amount of time (and energy) to grow the bubble under exposure to ultrasound irradiation to a point that it will undergo inertial cavitation. The structure of the nanoparticle determines the size of the gas bubble trapped. Generally, the bubble trapped will be no larger than the size of the nanoparticle.

Accordingly, it is preferred that the nanoparticle is sub-micron sized, meaning that it has a maximum diameter of 1 micron. Preferably the nanoparticle has a diameter of less than 1 micron. Particularly preferably, the nanoparticle may have a maximum diameter of from 50 nm to 500 nm, more preferably from 100 nm to 300 nm. Generally the nanoparticle will have a diameter of at least 5 nm, preferably at least 10 nm, for instance at least 20 nm or at least 50 nm. For instance, the nanoparticle may have a diameter in the range of 5 nm to 1000 nm, preferably 10 nm to 500 nm, more preferably 20 nm to 300 nm. Such nanoparticles trap gas bubbles which are susceptible to excitation by ultrasound, particularly by pulsed focussed ultrasound, allowing spatially-controlled experiments to be performed at relatively low excitation energies.

By “diameter” is meant the largest dimension of the nanoparticle in any direction. The diameter of the particle may be determined by any suitable method, such as by analysing the nanoparticle under TEM or STEM.

Another measurement of particle size which is useful in this context is the hydrodynamic diameter. The hydrodynamic diameter may be measured by dynamic light scattering using conventional instruments. Preferably the hydrodynamic diameter is less than 1 micron. Particularly preferably, the nanoparticle may have a maximum hydrodynamic diameter of from 50 nm to 500 nm, more preferably from 100 nm to 300 nm. Generally the nanoparticle will have a hydrodynamic diameter of at least 5 nm, preferably at least 10 nm, for instance at least 20 nm or at least 50 nm. For instance, the nanoparticle may have a hydrodynamic diameter in the range of 5 nm to 1000 nm, preferably 10 nm to 500 nm, more preferably 20 nm to 300 nm.

It is also important to note that the sonocatalyst of the invention may comprise a plurality of nanoparticles. While the sonocatalyst preferably comprises a nanoparticle of a size and structure as described above, other nanoparticles may also be present in the composition. For instance, a sonocatalyst may comprise an ensemble of particles comprising one or more nanoparticles as described herein, and additionally larger nanoparticles with a diameter (or hydrodynamic diameter) of up to 5 microns or up to 10 microns.

Preferably, the sonocatalyst comprises several nanoparticles as described herein. Thus, the invention provides a sonocatalyst which comprises a plurality of nanoparticles as described herein.

The structure of the sonocatalyst is such that a gas bubble can be trapped, which is susceptible to inertial cavitation under the influence of ultrasound. The ultrasound is preferably high-frequency ultrasound, which can be focussed and thus allow spatial control of the reaction. Under exposure to ultrasound, the trapped gas bubble undergoes inertial cavitation to release reactive species which can initiate a chemical reaction with a reagent in the vicinity of the sonocatalyst. Accordingly, the sonocatalyst is typically a catalyst capable of trapping a gas bubble which is susceptible to inertial cavitation upon exposure to ultrasound. In particular, the sonocatalyst is typically capable of generating reactive species upon excitation by exposure to ultrasound. The reactive species are typically reactive oxygen species (such as radical reactive oxygen species, e.g. hydroxyl radicals or singlet oxygen) or other radical species. The ultrasound is generally ultrasound at frequencies of above 100 kHz, preferably from 200 kHz to 500 kHz.

In use, the sonocatalyst nanoparticle is provided in a liquid medium and traps a gas bubble. Accordingly, the invention provides a composition comprising a liquid medium and a sonocatalyst as described herein, wherein the nanoparticle is associated with a trapped gas bubble. The liquid medium may be, for instance, an aqueous medium such as water. The gas bubble may comprise oxygen, nitrogen, ammonia or other suitable gaseous species; preferably the gas bubble comprises oxygen. For instance, the gas bubble may be an air bubble.

In general, the invention concerns a submicron-sized solid particle (the nanoparticle) with a surface cavity laden shell structure capable of trapping gas; which particle is capable of generating multiple reactive species upon exposure to ultrasound at frequencies above 100 kHz.

### Synthesis of the Nanoparticle(s)

The structure of the nanoparticle can be determined by its synthesis. A typical method of generating a nanoparticle described herein involves:
providing a template;
depositing a material on the template structure to create a shell structure around the template;
fracturing the shell structure; and
removing the template.

The template is typically a nanoscale template. For instance, the template typically has at least one nanoscale dimension (in the range of 1 nm to 1000 nm). Preferably, the template has a maximum diameter in the region of 1 to 1000 nm. The template may for instance be a spherical structure such as a nanobead.

The template is typically made of a material which is susceptible to pyrolysis. For instance, the template typically comprises or consists of a plastic, generally polystyrene.

The process may comprise a heating step to remove the template and optionally to calcine the shell structure.

The step of fracturing the shell structure may be performed before or after the template is removed. The fracturing of the shell structure may involve, for instance, milling the shell structure.

### Catalytic Material of the Nanoparticle(s)

The function of the sonocatalyst described herein is twofold. One function, as discussed above, is to trap a gas bubble which is susceptible to inertial cavitation under the influence of ultrasound. The other key function is act as a catalyst for a relevant chemical reaction. In order to enable the sonocatalyst to act as a catalyst, the nanoparticle(s) comprised in the sonocatalyst typically comprises one or more catalytic materials.

A catalytic material is a material able to act as a catalyst. The catalytic material is selected for its ability to act as a catalyst for a relevant reaction. For instance, if the chemical reaction desired is an oxidation reaction, the catalytic material will be able to catalyse the oxidation reaction. Similarly, if the chemical reaction desired is a reduction reaction, the catalytic material will be able to catalyse the reduction reaction.

A preferred class of catalytic materials is electrochemical catalysts. These materials include electron donors or acceptors, and are often metals, such as noble metals, for instance, gold or platinum. Thus, in a preferred embodiment the nanoparticle comprises a catalytic material which is an electrochemical catalyst. For instance, the nanoparticle may comprise a catalytic material which is a metal, preferably gold.

Another preferred class of catalysts is catalysts which can act as catalysts when stimulated by electromagnetic radiation. For instance, the nanoparticle may comprise a catalytic material which can be stimulated by UV radiation, visible light, near IR or IR radiation. In a particular example, the sonocatalyst may comprise a nanoparticle wherein the nanoparticle comprises a catalytic material having an electron-hole pair which can be excited by electromagnetic radiation having a wavelength in the range 10 nm to 1400, preferably 10 nm to 700 nm (UV or visible light). The electromagnetic radiation may be UV light, having a wavelength in the region 10 nm to 400 nm. The electromagnetic radiation may alternatively be visible light, having a wavelength in the region 400 nm to 700 nm.

A particularly preferred class of catalytic materials is photocatalysts. These catalytic materials are stimulated by visible light. Thus, in the sonocatalyst described herein, the nanoparticle may comprise a catalytic material which is a photocatalyst. In such cases the sonocatalyst may be described as a sonophotocatalyst.

Photocatalysts are a known class of materials which decompose detrimental substances when exposed to UV and/or visible light, particularly UV light. They are understood to function by the excitation of electrons and holes under UV or visible light. A particular example is titania, TiO₂. Exposure to UV or visible light generates electrons which can produce anionic radicals such as O₂⁻, or radicals such as OH radicals, in the presence of air or water. These highly active species decompose chemicals such as organic compounds. Accordingly, in a preferred embodiment, the nanoparticle comprises a photocatalyst which promotes the formation of radical species and/or reactive oxygen species, preferably radical reactive oxygen species, particularly preferably hydroxyl radicals and/or singlet oxygen.

A variety of materials are known to act as photocatalysts. Preferably, the nanoparticle may include such a photocatalyst. These can include proteins and polymers, but are more commonly inorganic compounds such as metal oxides, metal sulphides or metal nitrides. In an embodiment, therefore, the sonocatalyst comprises a catalytic material which is a metal oxide or metal sulphide or metal nitride. Typically, the metal oxide, metal sulphide or metal nitride has activity as a photocatalyst. For instance, the metal oxide, metal sulphide or metal nitride can liberate electrons on exposure to UV or visible light.

Particularly preferred catalytic materials are metal oxides, in particular metal oxides which are photocatalysts. Thus, the sonocatalyst described herein may comprise a nanoparticle which comprises a catalytic material which is selected from a titanium oxide such as TiO₂ or FeTiO₂, a strontium oxide such as SrO₂ or SrTiO₃, a zirconium oxide such as ZrO₂, a tantalum oxide such as Ta₂O₅, a Niobium oxide such as K₄Nb₆O₁₇, a tungsten oxide such as WO₃, or a zinc oxide such as ZnO. Preferably the catalytic material is TiO₂. In particular, the nanoparticle may comprise or consist of TiO₂. Preferably, some or all of the TiO₂ is in the anatase phase.

Not only the catalytic material present in the nanoparticle, but also the structure of the nanoparticle may affect its ability to function as a catalyst. For instance, some materials do not act as catalysts in bulk but demonstrate catalytic activity when they adopt a nanostructure form. As is discussed herein, the inventors have shown that a noble metal (gold) may demonstrate catalytic activity when adopting a form comprising dendrite structures a few nm thick.

Thus, the sonocatalyst of the invention may comprise a nanoparticle comprising a catalytic material having a catalytic structure. For instance, the nanoparticle may comprise a catalytic material wherein the catalytic material is arranged such that it has at least one dimension of 10 nm or less, preferably 5 nm or less.

For example, the nanoparticle may comprise a dendritic structure containing at least one dendrite wherein the dendrite has a smallest dimension of 10 nm or less, preferably 5 nm or less. The nanoparticle may comprise a plurality of such dendritic structures. In a particular example, the nanoparticle may comprise a dendritic gold structure containing a plurality of dendrites wherein each dendrite has a smallest dimension of 10 nm or less. Optionally the dendrites may be arranged to form a nanocone structure.

### Nanoparticles Containing Multiple Materials

The nanoparticles may contain a single material. In such a case, the material must have catalytic activity and must adopt a structure capable of trapping gas. However, the two key functions may also be provided by different materials. For instance, the nanoparticle may comprise a first material having a structure capable of trapping gas, which is decorated with a second material having catalytic activity.

Thus, in an embodiment of the sonocatalyst described herein, the nanoparticle may comprise two or more catalytic materials. Each catalytic material is preferably selected from a catalytic material as described herein. For instance, the nanoparticle may comprise a first catalytic material which is a metal oxide, and a second catalytic material which is a metal. Particularly preferably, the nanoparticle may comprise a first catalytic material which is titania, and a second catalytic material which is gold. Particularly preferably, the gold is provided having a smallest dimension of 10 nm or less, for instance in the form of dendrites or drops.

### Gold Nanoparticles

As explained above, in a preferred embodiment, the sonocatalyst of the invention may comprise one or more gold nanoparticles. These have surprisingly been found to show sonocatalytic activity. Thus, the invention provides the following.

1. A use of gold nanocones comprising
a) Providing AuNCs and at least one reactant in a liquid medium to form a mixture;
b) Subjecting the mixture to ultrasonic irradiation to activate a reaction.

2. The use according to 1, wherein the gold nanocones have a hydrodynamic diameter of 142±13.9 nm to 205±20 nm when stabilizing gas bubbles, as measured by dynamic light scattering (DLS).

3. The use according to 1 or 2, wherein the ultrasonic irradiation comprises a frequency of at least 100 kHz.

4. The use according to any one of 1 to 3, wherein the reaction is a reduction reaction (e.g. reduction of 4-nitrophenol to 4-aminophenol, methylene blue reduction to oxidation and/or reduction products).

### Method

The sonocatalyst described herein can be used to catalyse a chemical reaction. The chemical reaction catalysed may be initiated by the reactive species (such as radicals) generated by inertial cavitation. The chemical reaction may involve multiple steps, and the sonocatalyst may catalyse one or more steps in the chemical reaction.

Thus, described herein is a method of catalysing a chemical reaction, the method comprising:
(i) providing a sonocatalyst; and
(ii) exposing the sonocatalyst to ultrasound.
   wherein the sonocatalyst is as described herein.

In practice, the reaction occurs in a liquid medium, typically an aqueous medium. The sonocatalyst comprises a nanoparticle associated with a trapped gas bubble. Thus, the method of catalysing a recation concerns:
(i) providing a sonocatalyst comprising a nanoparticle associated with a gas bubble in a liquid medium; and
(ii) exposing the sonocatalyst to ultrasound irradiation to activate the reaction.
   wherein the nanoparticle is as described herein.

The gas bubble typically comprises oxygen. For instance, the gas bubble may be an air bubble. The gas bubble is trapped by the nanoparticle.

In order to trap a gas bubble in association with the nanoparticle, the nanoparticle can be dried in the presence of a gas. For instance, the nanoparticle may initially be dried and exposed to air. Thus, the method of catalysing a reaction may comprise:
(i) drying a sonocatalyst comprising a nanoparticle in a gas, and then adding the dried sonocatalyst to a liquid medium to form a mixture wherein a gas bubble is associated with the nanoparticle; and
(ii) exposing the sonocatalyst to ultrasound irradiation to activate the reaction.

The nanoparticle is as described herein.

Exposing the sonocatalyst to ultrasound can activate the chemical reaction, by causing inertial cavitation at the site of the nanoparticle to generate reactive species (such as radicals) which may initiate the reaction. Accordingly, in some embodiments of the method described herein, the ultrasound causes a gas bubble trapped by the nanoparticle to undergo inertial cavitation, optionally generating reactive chemical species at the locus of the nanoparticle.

The method may or may not involve adding a chemical reagent. Actively providing a chemical reagent may not be necessary, if the method is simply performed at a location where the chemical reagent(s) of interest are present (for instance, disposed on the wall of a container). In other embodiments, however, the method involves providing one or more chemical reagents. Thus, step (i) of the process may additionally comprise contacting the sonocatalyst with a chemical reagent.

For instance, the method of catalysing a reaction may comprise:
(i) drying a sonocatalyst comprising a nanoparticle in a gas, and then adding the dried sonocatalyst to a liquid medium to form a mixture wherein a gas bubble is associated with the nanoparticle, and adding a chemical reagent to the liquid medium; and
(ii) exposing the sonocatalyst to ultrasound irradiation to activate a reaction involving the chemical reagent.

The nanoparticle is as described herein. The chemical reagent may be added to the liquid medium before or after the sonocatalyst is added to the liquid medium, or at the same time.

The nature of the ultrasound radiation used during the method of the invention can be varied. Note that “ultrasound”, “ultrasound irradiation” and “ultrasound radiation” are used interchangeably herein.

In some embodiments, the ultrasound may be pulsed ultrasound. In other embodiments, the ultrasound may be continuous ultrasound. It may be preferred to provide pulsed ultrasound, which can make the process more energy-efficient.

In some embodiments, the ultrasound may be focussed. This enables the reaction to be localised at the focal point of the ultrasound, permitting spatial control of the reaction. It is particularly desirable to provide high-frequency pulsed ultrasound, which can be focussed.

Thus, in a preferred embodiment, the ultrasound is pulsed focussed ultrasound. for example focussed pulsed high-frequency ultrasound.

Generally, the frequency of the ultrasound is greater than 100 kHz. If the frequency of the ultrasound is too high, a trapped gas bubble may not be able to absorb energy and grow. However, higher frequencies can be desirable as this can reduce the amount of time needed to maintain the system at a high voltage, making the process more efficient overall; moreover, higher frequencies have been found to suppress random variations in the inertial cavitation process and lead to a highly controlled reaction. Further, if the frequency of the ultrasound is too low, the gas bubble can absorb energy and grow in a slower, more stable fashion, reducing the likelihood of inertial cavitation. The optimal frequency can vary depending on the size of gas bubble trapped, but is generally greater than 100 kHz. Typically the frequency of the ultrasound is less than 1 MHz. Preferably, the frequency of the ultrasound is from 200 kHz to 500 kHz.

Where the nanoparticle(s) of the sonocatalyst can be stimulated by electromagnetic radiation, the process may also comprise exposing the sonocatalyst to electromagnetic radiation. The electromagnetic radiation is typically UV or visible light. Generally, the sonocatalyst is exposed to electromagnetic radiation in the mixture undergoing reaction. Thus, the method may comprise:
(i) providing a sonocatalyst;
(ii) exposing the sonocatalyst to ultrasound; and
(iii) exposing the sonocatalyst to UV light and/or visible light.

For instance, the method may comprise:
(i) drying a sonocatalyst comprising a nanoparticle in a gas, and then adding the dried sonocatalyst to a liquid medium to form a mixture wherein a gas bubble is associated with the nanoparticle;
(ii) exposing the sonocatalyst to ultrasound irradiation to activate the reaction; and
(iii) exposing the sonocatalyst to UV light and/or visible light.

Step (iii) may be performed before, during or after step (ii). In such embodiments, the sonocatalyst is preferably a sonophotocatalyst. Preferably the sonocatalyst comprises a nanoparticle comprising or consisting of a photocatalyst such as TiO₂.

### Use

The invention also concerns the use of a sonocatalyst to catalyse a chemical reaction, such as an oxidation reaction or a reduction reaction. The sonocatalyst is as described herein. Generally, this use of a sonocatalyst concerns the use of the sonocatalyst in a method as described herein.

### Apparatus

An apparatus for performing a use or method as described herein is well-known to the skilled person. Accordingly, the invention provides an apparatus for catalysing a chemical reaction, the apparatus comprising an ultrasound waveform generator and a sonocatalyst as described herein.

### EXAMPLES

Selected representative images of the particles and demonstration of effects are shown in the attached figures, and a brief description of the technology is as follows with respect to two exemplary systems.

The first exemplary system employs titania nanoparticles as the sonocatalyst. Hollow titanium nanoparticles were generated using a polystyrene template and then fractured. The ability of these nanoparticles to act as nuclei for inertial cavitation, and to catalyse chemical reactions initiated in the vicinity of the nanoparticles, is demonstrated below.

### TFNs Hollow Sphere Synthesis

TFNs hollow spheres were formed by sol-gel template synthesis.(33) 10 wt % Polystyrene (PS) particles (300 nm, PL6003 Agilent, USA) were dispersed in absolute alcohol (107017 Millipore, 1:11 v/v) and sonicated for 10 minutes. The solution was then allowed to stir at 400 RPM while titanium butoxide (244112 Sigma, 0.2:1 in ethanol v/v) was added dropwise to the mixture. This solution was then sealed and allowed to stir for 2 hours at room temperature, after which the particles were washed in ethanol by centrifugation at 4000 RCF for 10 minutes. After washing, the supernatant was removed and the particles were dried overnight at 60° C. prior to calcination (5° C./min temperature ramp) at 500° C. for 3 hours, followed by air cooling to ambient temperature. The particles were then collected and stored in a dry cabinet at 30% humidity until ready for use.

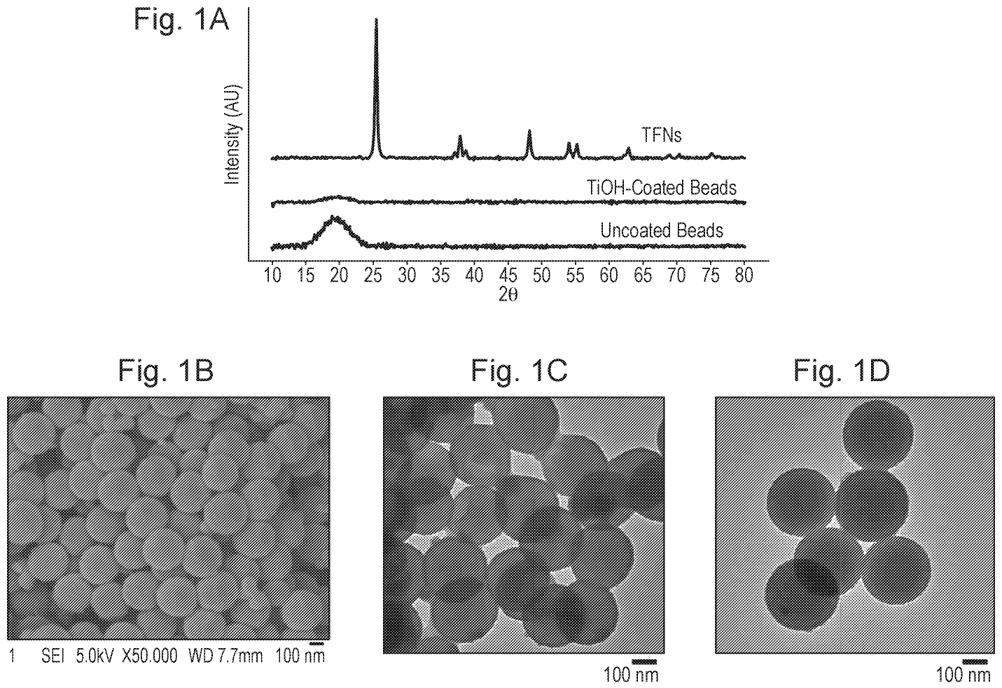

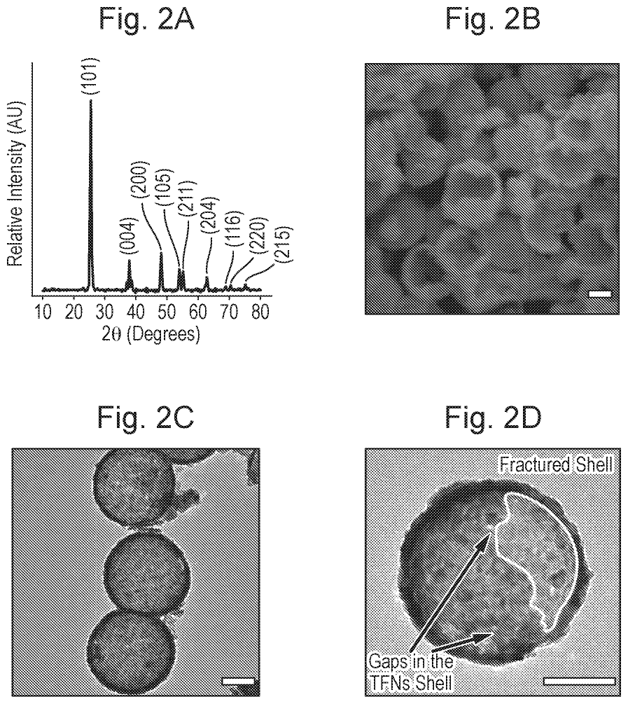

Prior to calcination, the crystalline structure of the titanium coated particles was assessed by XRD to be amorphous (FIG. 1A), with the primary peak observed to come from the polystyrene core. Electron microscopy was performed to assess the surface coating of the polystyrene particles, where the particles were observed to have a slightly rough surface by SEM imaging (FIG. 1B). By TEM, the titanium precursor is seen to coat the polystyrene particles uniformly as evident by the darker rim contrast in FIG. 1C-D. After calcination, the particle diameter reduced from 300 nm to approximately 140 nm. The crystal structure of the particles was confirmed to have formed a predominant anatase structure, confirming the synthesis of TiO₂ with minimal impurities (FIG. 2A).(34) TFNs were then milled with a microspatula to form fractured nanoshells (TFNs) as observed by SEM (FIG. 2B). Here, the fractured particles were observed to have a thin shell, with some particles showing interstitial gaps in the shell. This was corroborated by TEM imaging, which confirmed a hollow particle structure with a shell thickness of 15 nm, as evidenced by the pixel intensity difference between the particle edge to the centre (FIG. 2C). By higher magnification on TEM, the large fractures and interstitial gaps in the shell can also be observed (FIG. 2D), suggesting a quasi-porous structure to the TFNs.

### Ultrasonic Irradiation of TFNs Solutions

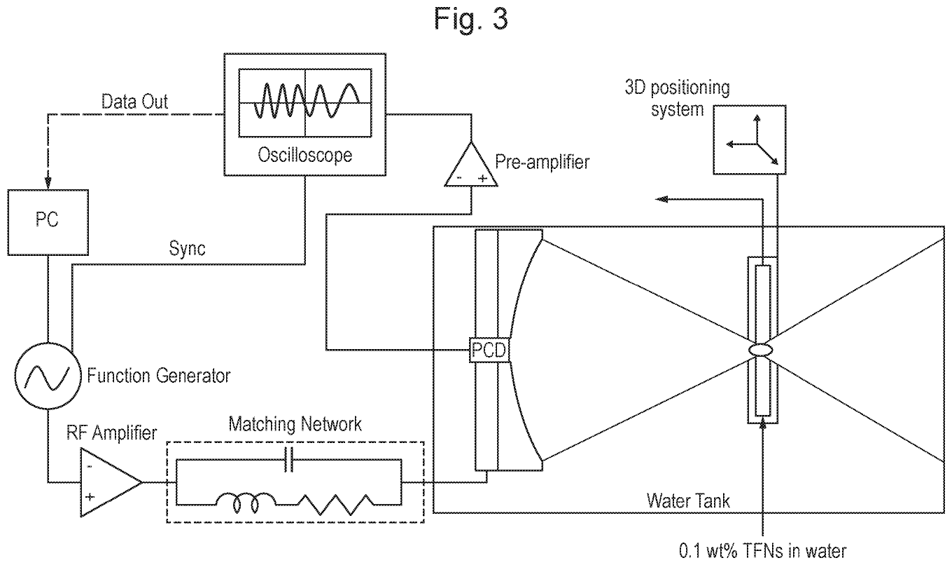

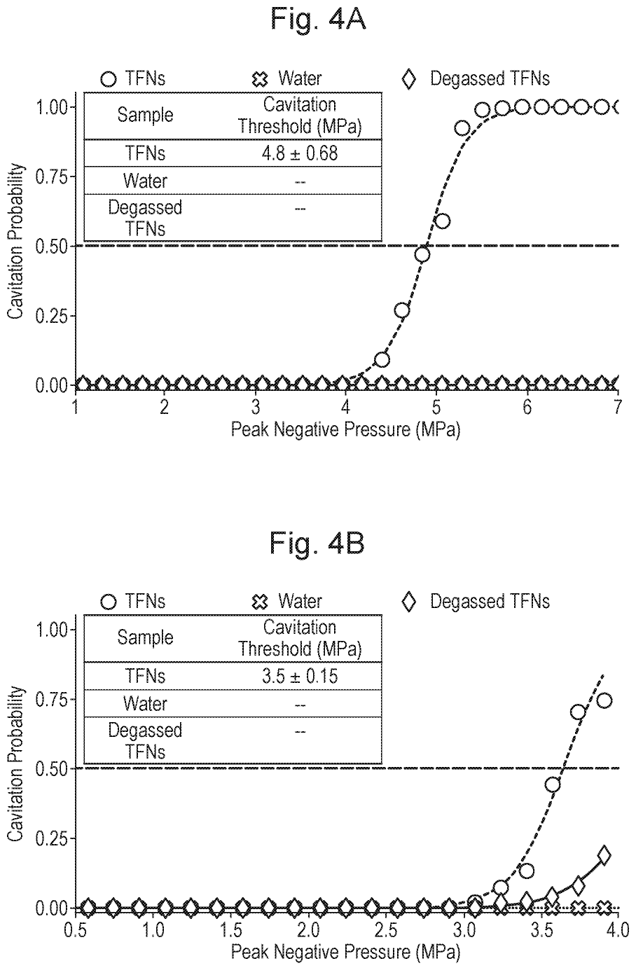

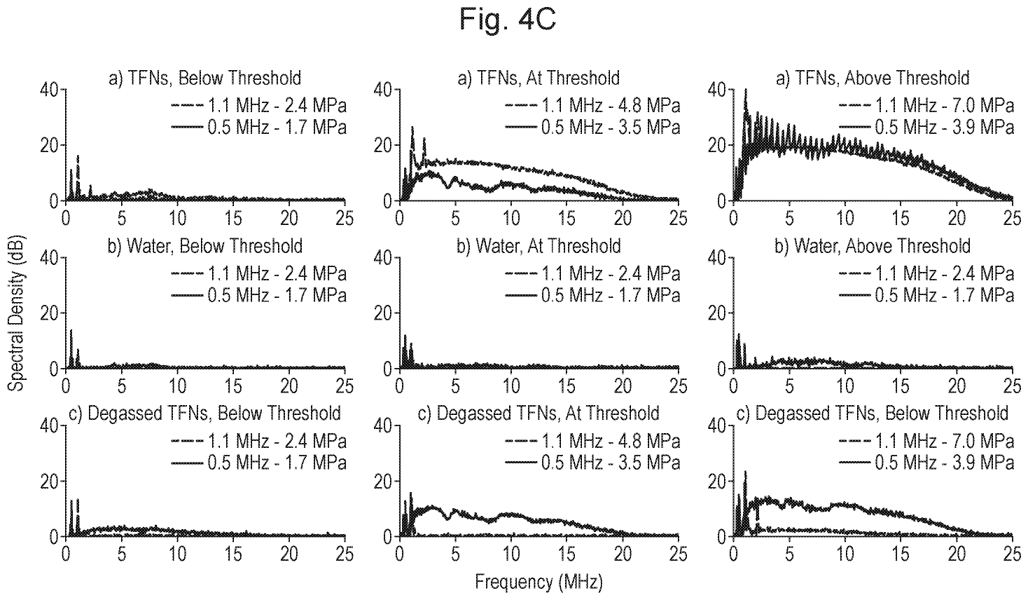

A conventional HIFU setup was used in all HIFU experiments (FIG. 3), and details of the setup are found in other reports.(35-37) In brief, a sine wave burst from a waveform generator was amplified by a 55 dB RF amplifier (Electronics and Innovation 1040L, Rochester NY) and passed through an electrical impedance matching network before reaching the HIFU transducer (1.1 MHz, Sonic Concepts, USA H-102 or 500 kHz, H-107). Irradiation parameters for both 1.1 MHz and 500 kHz were set to 45 msec pulse duration and a 33% duty cycle. Any acoustic response from the sample during HIFU exposure was detected by the PCD (15 MHz, Olympus, Japan VU-V319) and normalized against a free-field reference signal to obtain the power spectral density (PSD) curve. From these measurements, we calculated the probability for inertial cavitation at different acoustic pressure amplitudes for TFNs (1 mg/mL). A sigmoid function fit of the probability of cavitation indicated that the inertial cavitation threshold was approximately 4.8+0.68 MPa peak negative pressure at 1.1 MHz (FIG. 4A). Deionized water and degassing TFNs by ethanol washes did not cavitate at any pressure amplitude tested at 1.1 MHz. At 0.5 MHz (FIG. 4B, the inertial cavitation threshold for TFNs was 3.5+0.15 MPa peak negative pressure, substantially lower than at 1.1 MHz Interestingly, degassed TFNs particles were found to respond to 0.5 MHz, but the inertial cavitation threshold was never reached; the cavitation response was less frequent and less intense than the TFNs under similar acoustic conditions. Therefore, all subsequent studies at 0.5 and 1.1 MHz were performed at 4.0 and 6.8 MPa respectively to maximize the presence of cavitation. In FIG. 4C, we visualized the PSD curves for each sample below, equal to, and above the cavitation threshold for TFNs. The PSD curves indicate that that cavitation from TFNs emitted predominantly broadband noise, which is indicative of shockwave formation from inertial cavitation. Comparatively, water was not observed to exhibit much noise, while degassed TFNs emitted markedly less broadband noise than fresh particles at the same pressures.

Photocatalytic Degradation of MB with TFNs

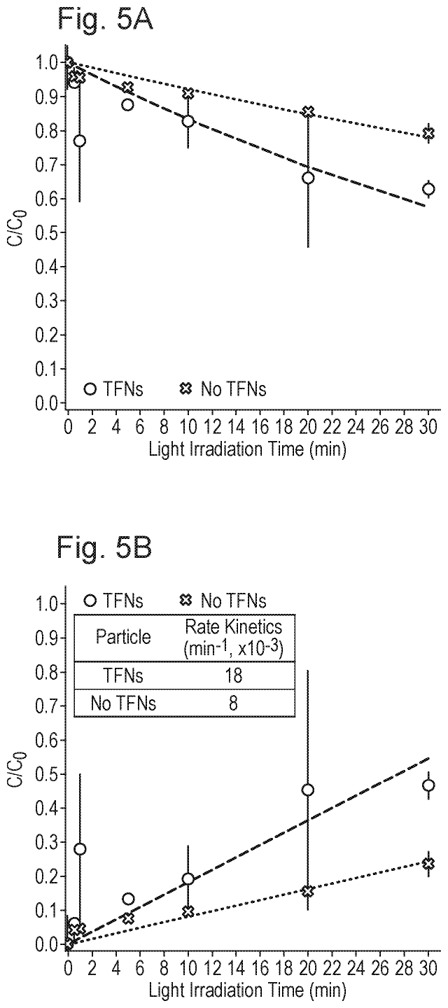

We next evaluated the photocatalytic activity of the TFNs by measuring the color degradation of MB using conventional light irradiation.(38) Solutions were irradiated with visible light with or without TFNs were light irradiated for up to 30 minutes (FIG. 5A). From this, the first order rate kinetics for photodegradation of MB was assessed and tabulated (FIG. 5B). In the absence of TFNs, there was a gradual degradation of MB (8×10⁻³ min⁻¹) upon exposure to light. In stark contrast, the degradation of MB in solutions containing TFNs was more than two-fold faster (18×10⁻³ min⁻¹).

Sonophotocatalytic Degradation of MB with TFNs

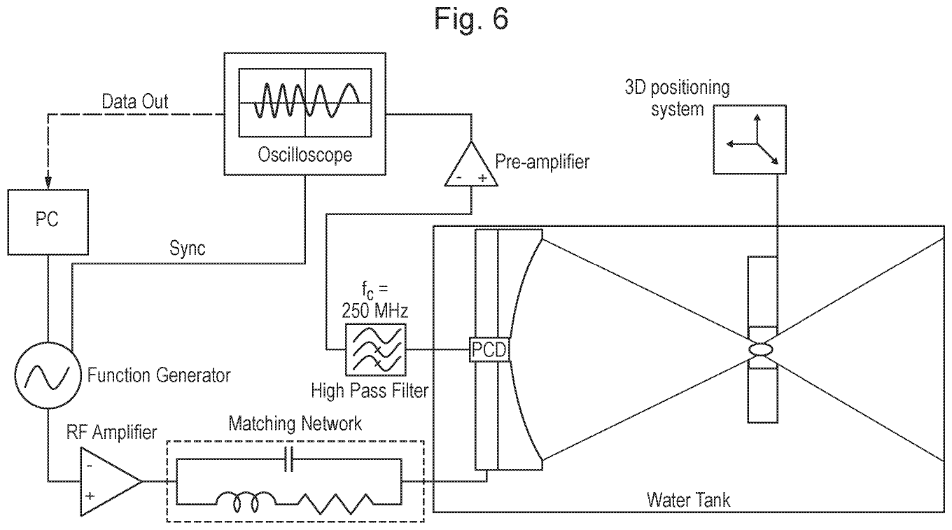

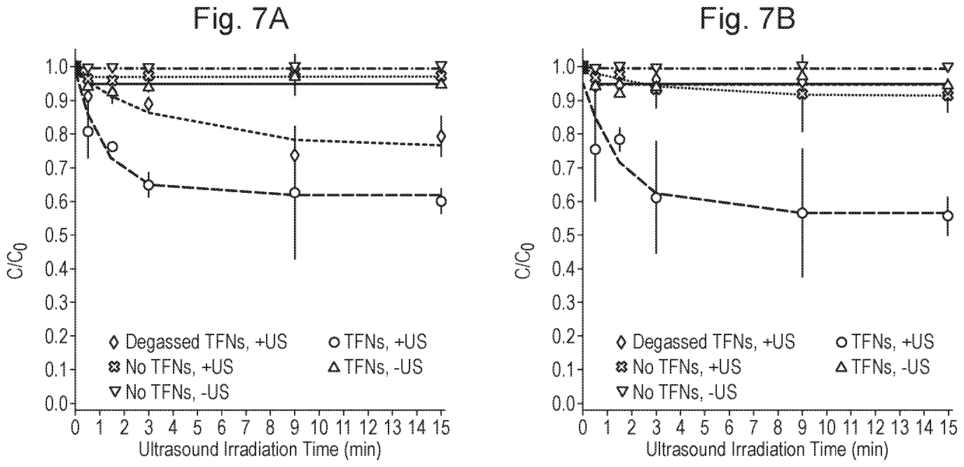

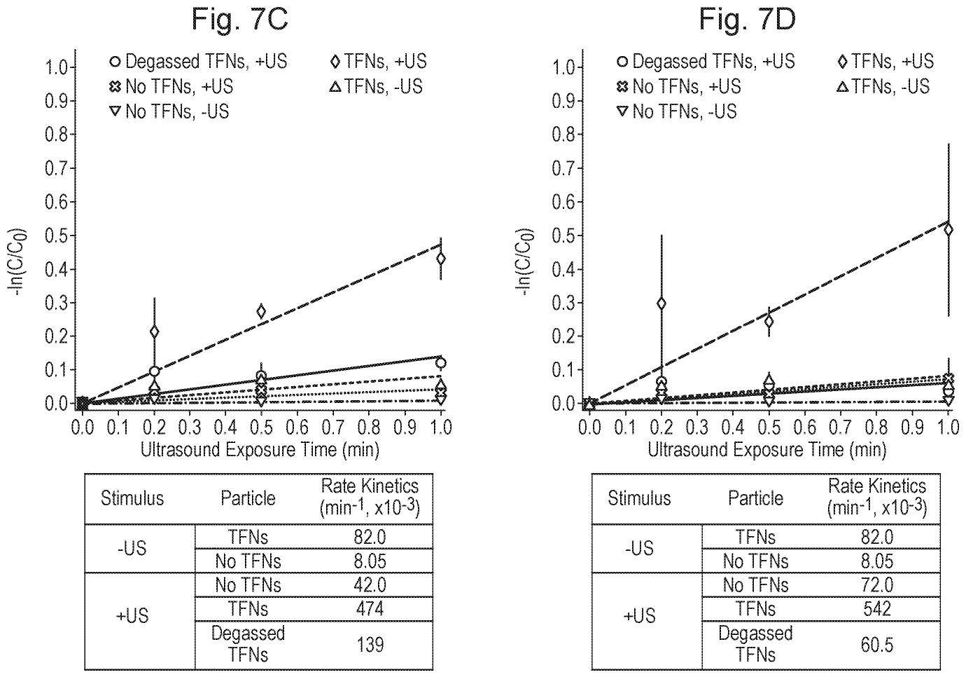

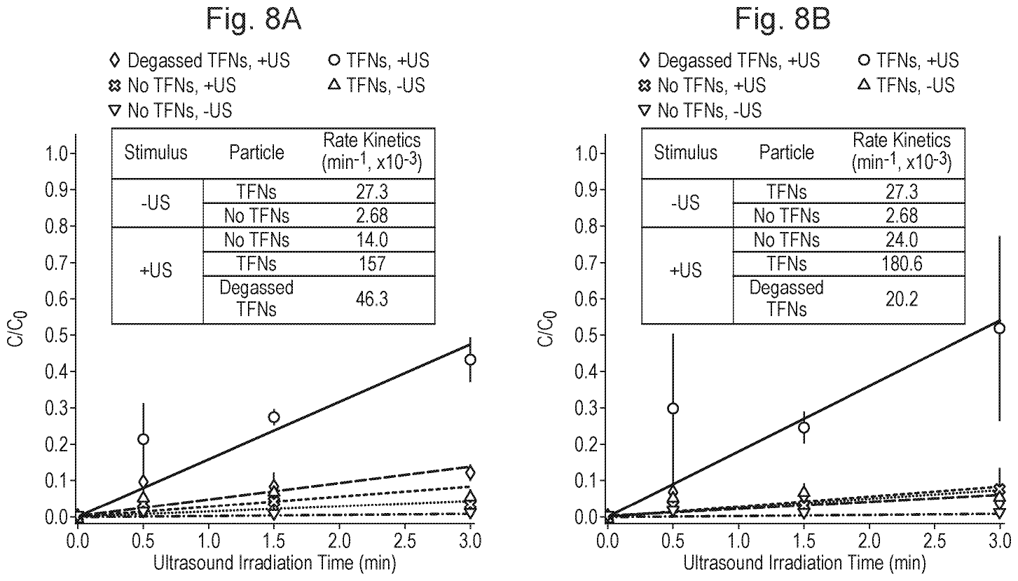

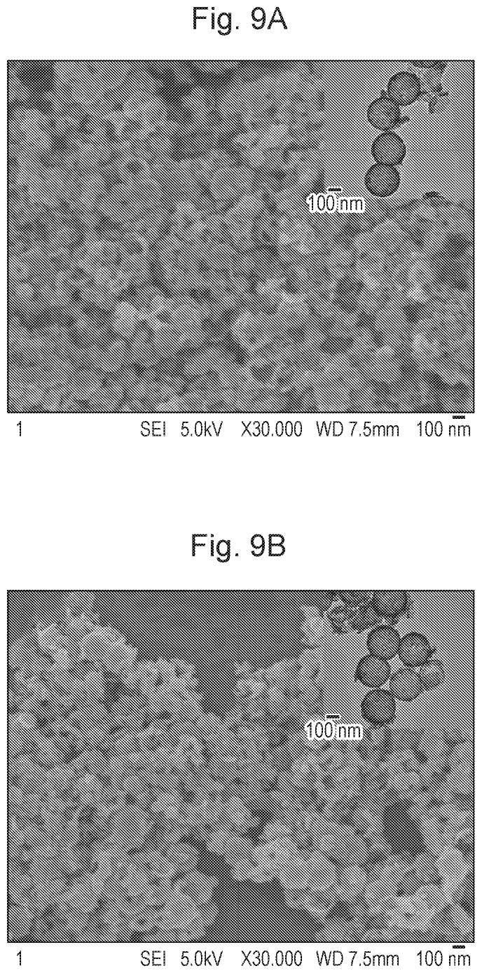

After confirming the photocatalytic capability of TFNs, the nanoparticles were assessed for their sonophotocatalytic performance by degrading MB within in an acoustically transparent static reaction chamber (FIG. 6). Different 5 μg/mL aqueous solutions of MB with TFNs, with degassed TFNs, or without TFNs were exposed to pulsed focused ultrasound for 0, 0.5, 1.5, 3, 9, and 15 minutes of ultrasound at either a 0% (i.e. no ultrasound) or 33% duty cycle. The resulting color degradation at each total elapsed time point are shown in FIG. 7A and FIG. 7B for 1.1 MHz and 0.5 MHz irradiation, respectively. Because our approach utilized pulsed ultrasound, we assessed the rate kinetics as a function of ultrasound exposure time and total elapsed time (FIG. 8). For all tested conditions, negligible degradation of MB was observed except for TFNs solutions exposed to pulsed focused ultrasound. The degradation rate of MB with TFNs at 1.1 MHz (FIG. 7C) was calculated to be 475×10⁻³ min⁻¹ mg⁻¹, an 11-fold increase compared to ultrasound only (42×10⁻³ min⁻¹ mg⁻¹) and a 5-fold increase compared to TFNs without ultrasound exposure (82×10⁻³ min⁻¹ mg⁻¹). Comparatively, reducing the frequency to 0.5 MHz (FIG. 7D) slightly increased the degradation rate with TFNs to 542×10⁻³ min⁻¹ mg⁻¹ . It is important to emphasize that TFNs were not destroyed from the exposure to ultrasound and cavitation (FIG. 9).

Degassed TFNs were also used to evaluate the importance of gas bubbles to facilitate the sonochemical degradation of MB. As expected, degassed TFNs produced fewer cavitation events during ultrasound irradiation. As a result, degassed TFNs degraded MB at substantially slower rates for both 0.5 and 1.1 MHz frequencies (60.5×10⁻³ and 139×10⁻³ min⁻¹ mg⁻¹, respectively) compared to TFNs.

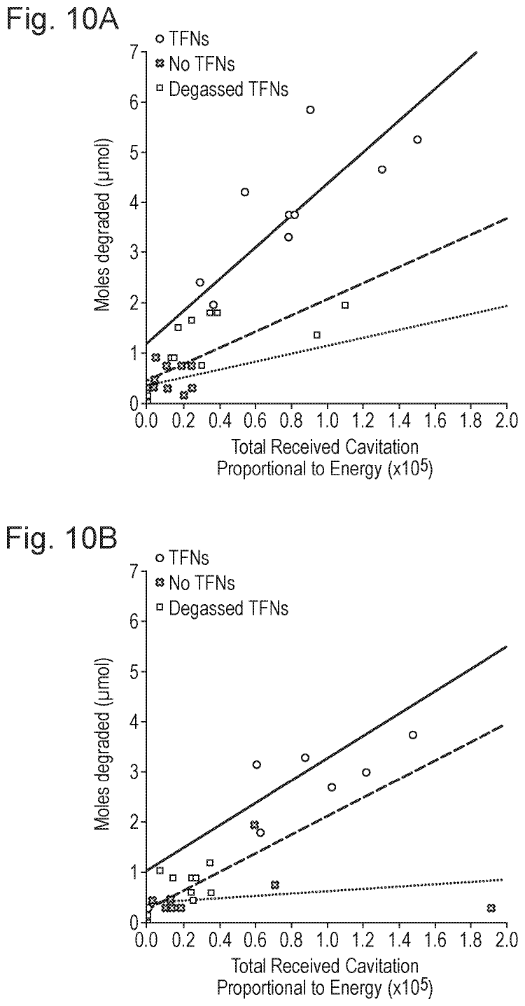

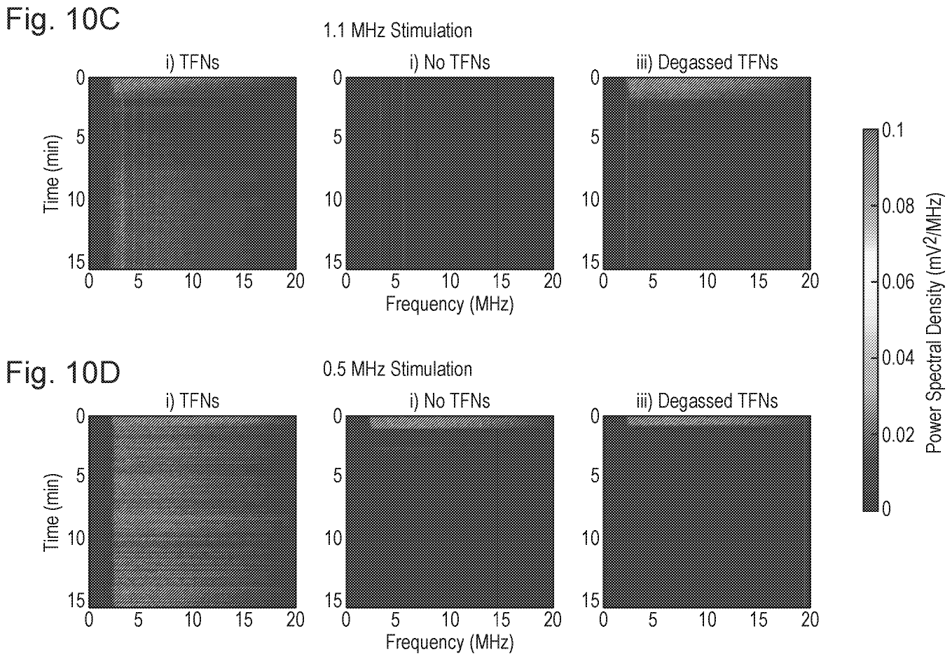

We also measured the noise emitted from the sonochemical reaction volume with a PCD to approximate the cavitation energy present during the reaction and correlate it to MB degradation (FIG. 10). These measurements indicated a direct positive correlation between cavitation energy and MB degradation for both 1.1 and 0.5 MHz (FIG. 10A and FIG. 10B, respectively). On further analysis of the cavitation dynamics, fresh TFNs afforded more sustained cavitation signal than no particles or the degassed TFNs when irradiated with either 1.1 and 0.5 MHz (FIG. 10C and FIG. 10D, respectively).

Sonophotocatalytic ROS Generation from TFNs

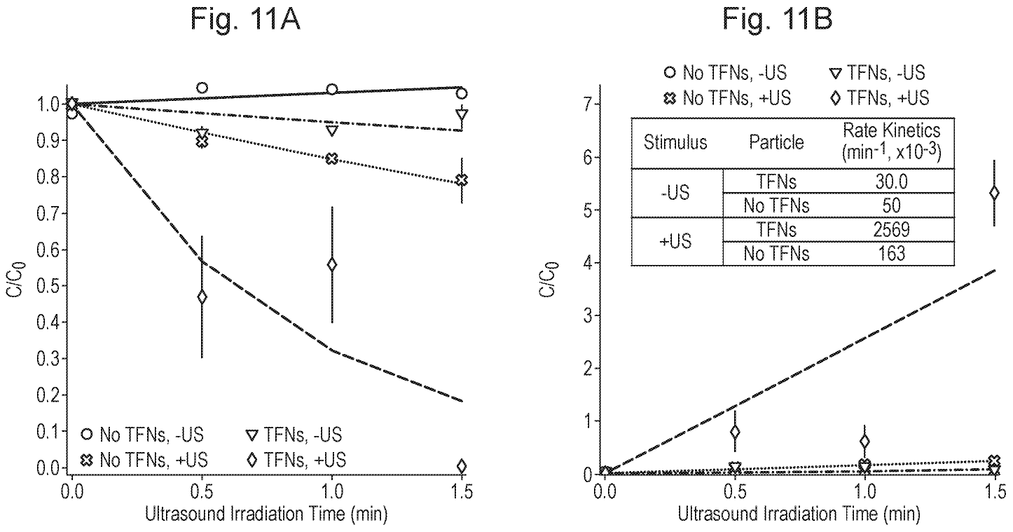

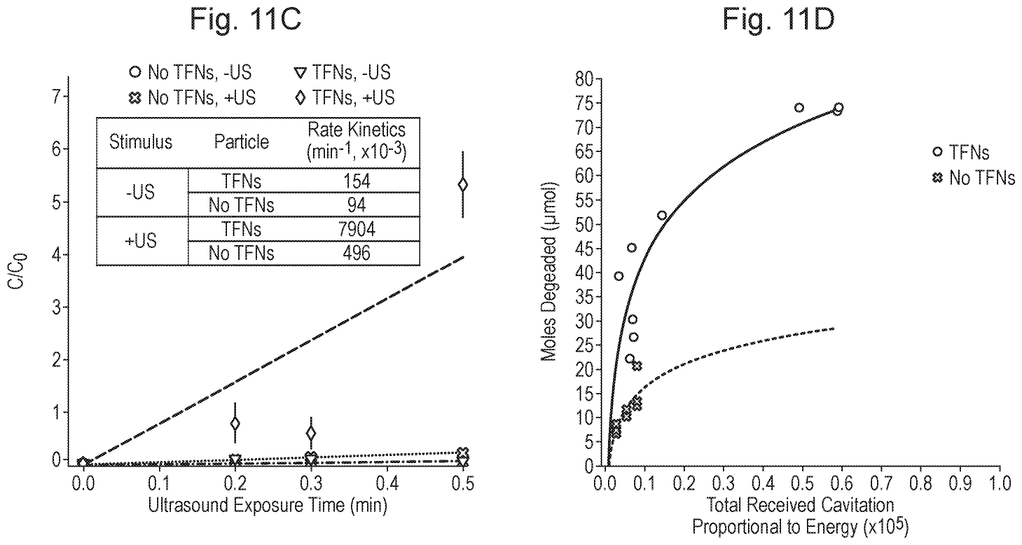

We next assessed degradation of DPBF, an established probe for singlet oxygen detection and other ROS.(24) At a 20 μg/mL concentration, we observed complete degradation of the probe within 30 seconds of ultrasound exposure (equivalently to 90 seconds of elapsed time) (FIG. 11A). Although ultrasound alone degraded the dye, the degradation rate was significantly slower than TFNs and generally more similar to the adsorption of the dye by the particles, which is approximately a 10% change over the total irradiation period. The rate kinetics for all conditions are summarized in the FIG. 11B and FIG. 11C insets. In brief, TFNs exposed to ultrasound degraded DPBF at a rate of 7904×10⁻³ min⁻¹ mg⁻¹, which was nearly 16-fold faster compared to ultrasound alone (498×10⁻³ min⁻¹ mg⁻¹). Similar to MB degradation, the breakdown of DPBF was proportional to the cavitation response in the reaction volume (FIG. 11D). Interestingly, less cavitation energy was required to fully degrade DPBF compared to MB, leading to a more exponential change in degradation with cavitation energy.

### Validation of ROS Generation at TFNs Surface

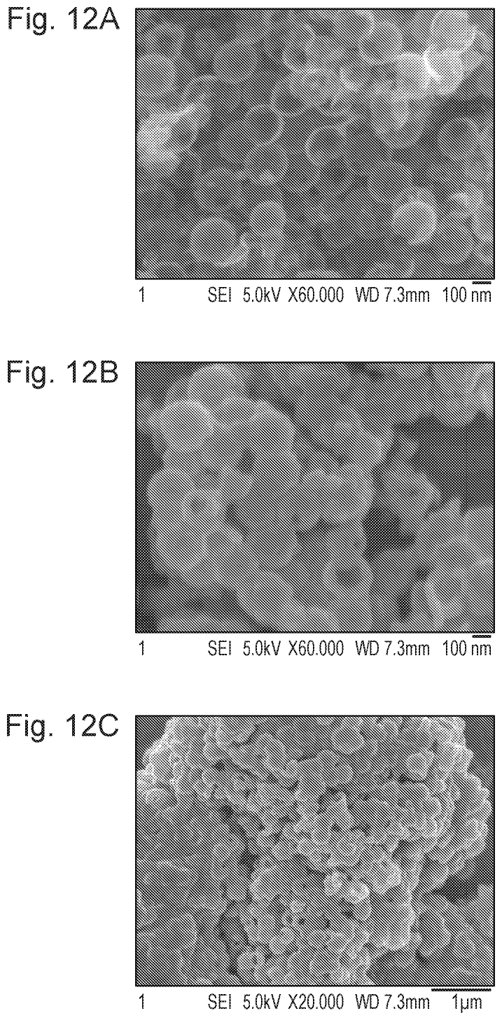

To further confirm that radical generation occurred by TFNs-induced cavitation, we utilized PEG700-diacrylate in a 20 wt % concentration in aqueous media with 2 mg/mL TFNs. By conventional polymer chemistry, radical initiators with interact with the π-bond on the acrylate group extend the polymer chain. In the case of this diacrylate monomer, where an acrylate group exists at the terminus of the PEG compound, a gel network will form, thereby allowing for facile validation on the influence of TFNs-based cavitation to generate radicals. After ultrasound irradiation, it was observed that the TFNs expressed less defined morphology as the particles were coated with gel (FIG. 12A). Lower magnification images further shown that the particles formed agglomerates as the gel coating formed (FIG. 12B). Without ultrasound irradiation, however, no gel coating was observed by SEM and the hollow nanoshell morphology of the TFNs was distinct (FIG. 12C).

### Au/Pd Surface Modification of TFNs

TFNs were surface modified with Au/Pd nanoparticles (Au/Pd@TFNs) to validate their performance as a support structure with other nanomaterials for specific chemical reactions.

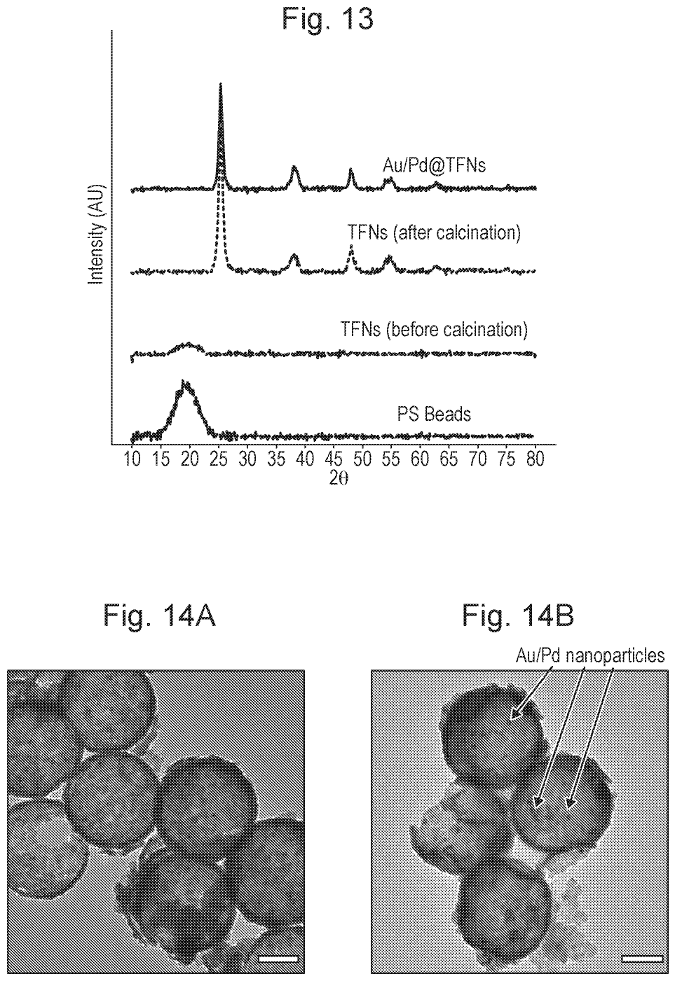

Au nanoparticles (NPs) were synthesized first, followed by alloying of Pd into Au NPs. In a typical procedure, 5 mL of oleylamine (OLAM, 70%, Sigma-Aldrich) was degassed under flowing Argon at 150° C. in a 50 mL flask. 0.3 mmol of HAuCl4·3H2O (99%, Sigma-Aldrich) was dissolved in 3 mL OLAM and the mixture was quickly injected into the hot OLAM solution, resulting a solution color change to dark purple. The heating was continued for 1.5 h before particles were precipitated with 50 mL of ethanol, followed by centrifugation at 11000 rpm for 5 min. Au/Pd NPs were synthesized using a modified seed-mediated process.(39) A mixture of Au NPs (30 mg) in hexane, OLAM (30 mL), oleic acid (1.9 mL, Sigma-Aldrich), and Pd(NO3)2·2H2O (15 mg, Sigma-Aldrich) was heated to 140° C. under flowing Argon in a 100 mL flask, and stirred for 30 min. The solution was cooled to room temperature and Au/Pd NPs were collected by precipitation and centrifugation for three times using isopropanol (5 mL) and ethanol (25 mL). Au/Pd NPs were loaded onto the TFNs surface by slowly adding a solution of Au/Pd NPs in 3 mL hexane to the dispersion of TFNs in 27 mL ethanol. The resulting particles were recovered by centrifugation and dried in oven for further use. The particles before and after modification were assessed by XRD to quantify crystal structure changes (FIG. 13). We found that the addition of Au/Pd nanoparticles did not incur an observable change in the spectra, likely as a result of the size and distribution of Au/Pd nanoparticles in relation to the TFNs particles. As a result, both TFNs and Au/Pd@TFNs presented a primarily anatase polymorph. On physical observation of the particle structure by electron microscopy, both TFNs-based particles were characterized by the same fractured hollow shell morphology, while the Au/Pd@TFNs particles were also presented to have nanodots randomly distributed along the TFNs surface (FIG. 14). These nanodots are likely the Au/Pd nanoparticles.

### Acoustic Response of Au/Pd@TFNs

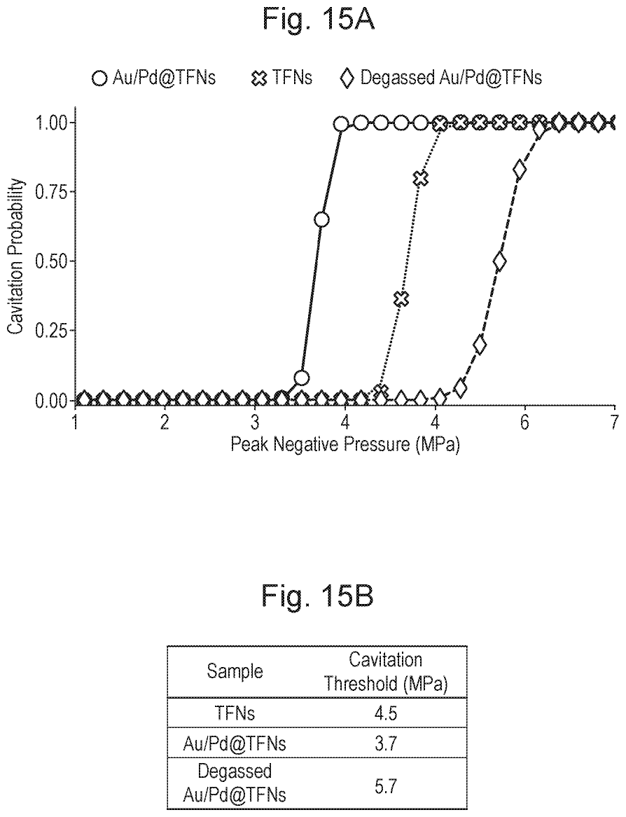

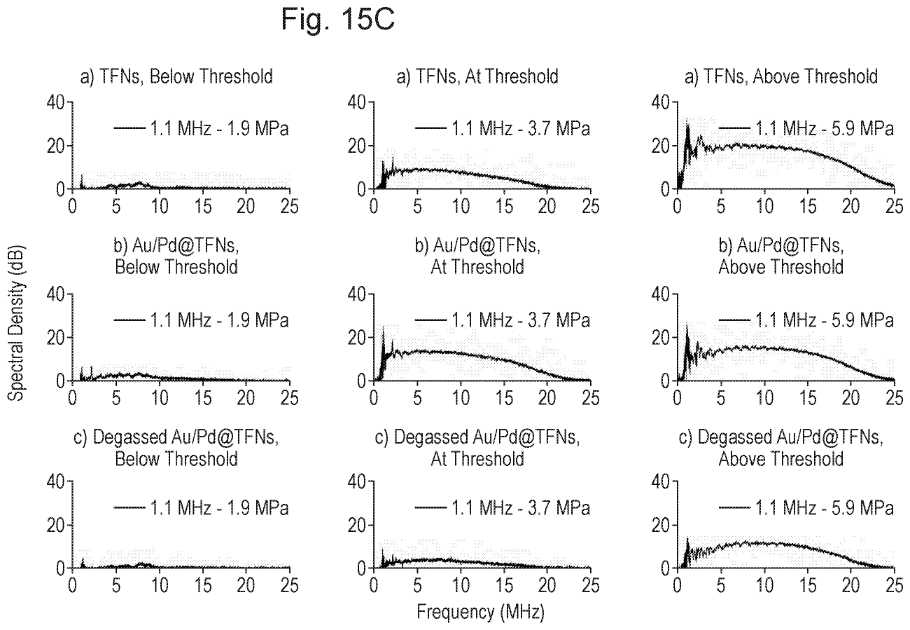

After validating the modification of TFNs with the Au/Pd nanoparticles, we assessed the particles for their acoustic response at 1.1 MHz (FIG. 15). Particle solutions were prepared at 1 mg/mL and irradiated to a range of pressures in an acoustically transparent flow chamber. A sigmoidal fit was used to determine the cavitation threshold pressure (pressure at which cavitation probability was 0.5) Interestingly, Au/Pd@TFNs particles were found have reduced the cavitation threshold of TFNs particles, thereby allowing a greater acoustic response at 3.7 MPa. Comparatively, degassed Au/Pd@TFNs still displayed a sigmoidal fit with the cavitation threshold at 6.0 MPa. Relative to TFNs, the reduced threshold of the Au/Pd@TFNs particles is likely a result of the Au/Pd particles being more hydrophobic than the TFNs support structure and allowing greater bubble entrapment than the unloaded particles. The change in the TFNs hydrophobicity will also mean that the particles are less likely to dewet by conventional ethanol washes, leading to degassed Au/Pd@TFNs exhibiting a response to the ultrasound, albeit at a greater pressure. All subsequent tests were performed at 7 MPa.

### Selective Oxidation by Au/Pd@TFNs

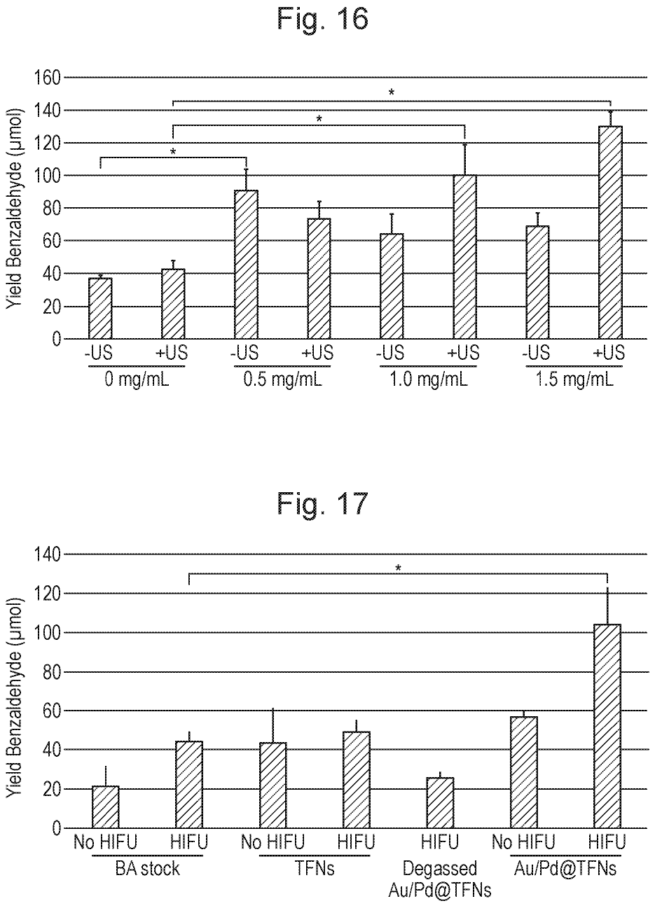

We next confirmed the minimum concentration of particles required to provide significant oxidation of benzyl alcohol. For this, we irradiated solutions of 500 ppm benzyl alcohol with 10 minutes of ultrasound at a 33% duty. Hydrogen peroxide was also added to the solution at a 5 moles equivalent to benzyl alcohol to function as a molecular oxygen source. The molar conversion of benzyl alcohol to benzaldehyde presented a linear increase as the particle concentration increased from 0 to 1.5 mg/mL (FIG. 16). We found that a minimum particle concentration of 1 mg/mL was required to produce a statistically significant increase in the benzaldehyde concentration following ultrasound irradiation from the negative control (no particles, with ultrasound) by one-way ANOVA at a 95% confidence interval.

We further evaluated the significance of site-specific cavitation using degassed Au/Pd@TFNs. While benzyaldehyde conversion was observed, no trend was observed with concentration. Following this, we validated the Au/Pd@TFNs performance for benzyaldehyde conversion against unloaded TFNs at a 1.5 mg/mL concentration. Here, benzaldehyde conversion was found to be comparable between the no particle control (BA stock), unloaded TFNs, and degassed Au/Pd@TFNs (FIG. 17). The ultrasound irradiated Au/Pd@TFNs group was the only sample that provided statistically significant increase in benzaldehyde yield to the ultrasound irradiated BA stock sample. All sample groups without ultrasound irradiation were found to be statistically indifferent by one-way ANOVA at a 95% confidence interval.

In a second set of examples, gold nanoparticles were synthesized and their sonocatalytic activity was demonstrated.

Gold catalysts have attracted attention for enabling sustainable chemical processes for wastewater treatment. However, gold catalysts remain difficult to remove from product streams due to their size (<5 nm) and often require rare-metal additives to enhance reaction rate kinetics, thereby limiting the environmental benefits of these catalysts. Submicron gold catalysts are easier to separate but are much less reactive. Here, we explore the catalytic performance of acoustically responsive submicron gold nanoparticles.

Specifically, we explore the potential of gas-stabilising gold nanocones (gs-AuNCs) to function as both cavitation nuclei and sonocatalyst, henceforth referred to as sonocatalytic cavitation agents. Unsupported gold nanocones (AuNCs) were fabricated with a well-defined submicron-scale conical “dendritic” structure with nano-scale multiple-branched petals. The surface cavities of AuNCs trap gas in the cavity. These surface-stabilised nanobubbles cavitate upon exposure to ultrasound. Acoustic noise from cavitation nucleated by gs-AuNCs exposed to focused ultrasound was measured with a passive cavitation detector (PCD). Additionally, we assessed the sonoreactivity of the gs-AuNCs in the presence of a reducing agent for degradation of 4-nitrophenol (4-NP) and methylene blue (MB), two model dyes conventionally used in gold catalysis and wastewater treatment. We also identified a direct correlation between the acoustic emissions generated by gs-AuNCs and the sonocatalytic degradation. Our results suggest that site-controlled cavitation plays a critical role for the efficient catalytic degradation of organic pollutants, guiding future advanced catalyst design for environmental remediation.

We demonstrate that submicron gold nanocones with well-defined multi-branched petals trap gas (gs-AuNCs) to function as both catalysts and cavitation nuclei. Cavitation nucleated from gs-AuNCs significantly increased the sonocatalytic degradation of water pollutants without the need for co-catalysts. The ability to amplify catalysis with ultrasound by tailoring the morphology of the catalyst to control cavitation opens new paths for future designs of sonocatalysts that may enable a sustainable chemical approach needed for a broad range of industrial processes.

### Materials

Gold(III) chloride hydrate (HAuC14, 99.999%), o-Phenetidine, hexane, sodium borohydride (NaBH4), 4-nitrophenol, and MB were purchased from Sigma-Aldrich and used as received. Agarose was bought from Vivantis Technologies. Deionized water was obtained from a pure water system (Stakpure, Germany).

### AuNCs Synthesis

AuNCs were made using a method adapted from Zhang et al [24]. In brief, upon ultrasound sonication, Au nuclei are immediately produced, and nuclei rapidly grow into hemispherical shells at the oil-water interface by a reducing HAuCl4 with o-phenetidine. Upon the continuous sonication, ultrasound results in the formation (vaporization of oil phase) and inertial collapse of bubbles, leading to the morphological transition of the half shells to conical structures.

Experimentally, 5 ml of 0.8 mM HAuCl4 aqueous solution was preheated at 50° C. for 5 min. 2.5 ml of 20 mM o-phenetidine in hexane was then gently layered on top of 0.8 mM HAuCl4 aqueous solution. The mixture was transferred to the ultrasonic bath (Cole-Parmer 08895-83) to initiate an interfacial reaction at an operating frequency of 40 kHz and a power of 160 W. After continuous sonication at 50° C. for 30 min, the solution was cooled in an icebath for one hour. The product was collected by centrifugation at 6000 rpm for 20 min. After freezing at −80° C. in an ultra-low-temperature freezer for 2 h, the samples were quickly transferred to a lyophilizer (Alpha 2-4 LSCbasic, Christ, Germany) and lyophilized for 24 h. After lyophilization, the samples were stored at −20° C. and sealed with parafilm to prevent moisture. Gas stabilization was accomplished by lyophilizing and resuspending the AuNCs so that they function as cavitation nuclei (gs-AuNCs).

### AuNCs Characterization

Size and morphology of AuNCs were obtained using a JEM-1400 (JEOL, Japan) transmission electron microscopy (TEM). Samples for TEM imaging were prepared by adding 10 μl of aqueous dispersions on 300-mesh carbon-coated copper grids. The grids were air-dried at room temperature. Size distributions were determined by dynamic light scattering (DLS) (Malvern Nano-ZS). The localised surface plasmon resonance peak of GNCs was detected using a UV-vis Spectrometer (Shimadzu UV 2450). The crystal structure of the AuNCs was examined by X-ray diffraction (XRD, Bruker D2 Phaser) by Cu Kα radiation with an accelerating voltage and current at 30 kV and 10 mA, respectively. The phase angle was adjusted between 5° and 40° at 0.05° increments (2Θ=10-80°) with a scan time of 0.5 seconds at each step).

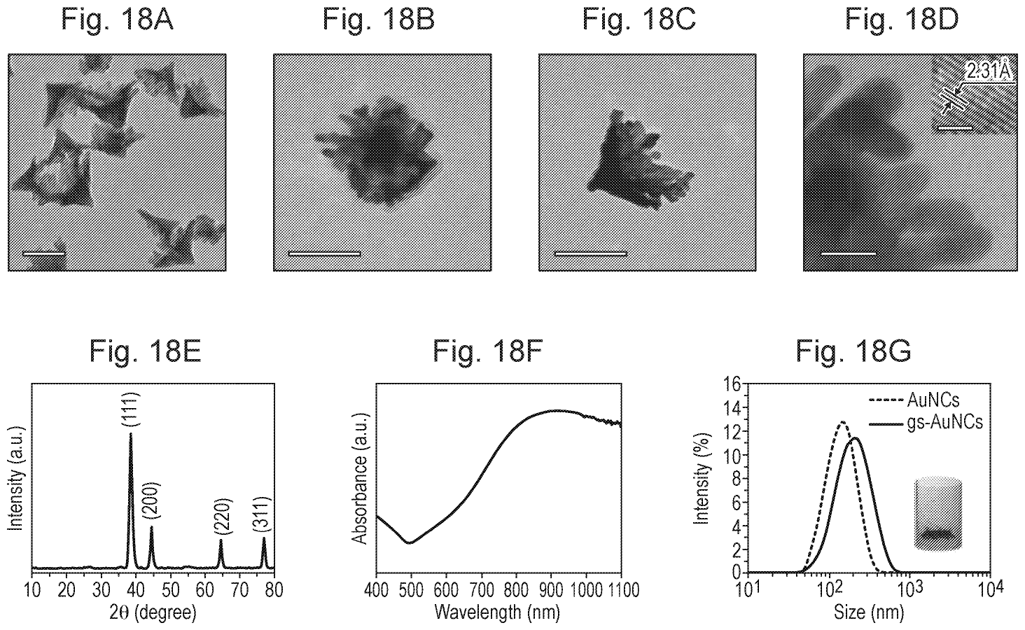

As shown in FIG. 18, the obtained cone-shaped particles present relatively sharp tips and broad opening bottoms with jagged edges. The base diameters of AuNCs were measured to be 169.5±21.70 nm and the cone height was a length of 115.9±17.1 nm. FIGS. 18b and 18c shows bottom and side TEM images of AuNCs. The AuNCs show well-defined hollow cavities comprising of “dendritic” structures. These “dendritic” structures consist of multiple-branched petals (˜6.8 nm) and narrow gaps (1-2 nm) (FIG. 18d). The high resolution TEM image (inset FIG. 18d) indicates that these petals are single crystalline and they grew along the (111) facets with a d-spacing of 0.23 nm. The crystallinity of AuNCs was further investigated using XRD (FIG. 18e). AuNCs with crystalline structure exhibited 4 characteristic diffraction peaks matched with (111), (200), (220), and (311) crystal planes of face-centred cubic gold [25]. AuNCs exhibit a characteristic localized surface plasmon resonance (SPR) peak at 900 nm (FIG. 18f). Gas stabilization on the AuNCs was successfully accomplished by drying the AuNCs and re-suspending the powder in degassed deionized water. DLS of AuNCs measured hydrodynamic diameters of 142.1±13.9 nm for AuNCs and 205.0±32.9 nm for gas stabilizing AuNCs (gs-AuNCs) (FIG. 18g). We suspect that the increase in average diameter was not due to aggregation, but instead due to the presence of a surface stabilized bubble [22].

### Ultrasound Setup

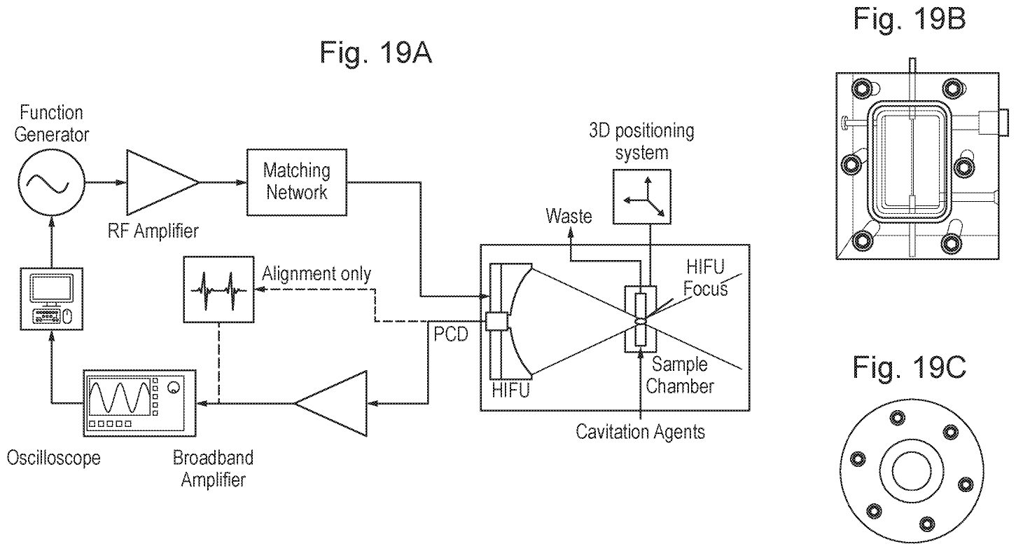

A conventional high intensity focused ultrasound (HIFU) setup was used in all HIFU experiments. A schematic of the experimental set-up for acoustic studies is shown in FIG. 19. A continuous flow chamber (FIG. 19b) was used for assessing the cavitation potential, and a static flow chamber (FIG. 19c) was used for catalytic study. The acoustically transparent agarose continuous flow sample chamber was made from a 2% (w/v) of agarose solution, which was boiled and degassed for 30 min to prevent cavitation as a result of endogenous bubbles. The agarose solution was then poured into a bespoke cuboid mold (50 mm in length×30 mm in width) and sealed with acoustically transparent windows. A 1.6 mm steel rod was threaded through the mold. After gelation was completed, the rod was removed, creating a flow channel

The static chamber consists of an acoustically transparent with a diameter of 18 mm and a depth of 5 mm (volume 1 ml).

AuNCs were prepared at a 1 mg/mL and 0.1 mg/ml working concentration in aqueous media. Solutions were then loaded into a continuous flow chamber at a continuous and constant flow of 200 μL/min through the channel. The continuous flow chamber was aligned at the focus of high intensity focused ultrasound transducer (1.1 MHz, Sonic Concept H102) for acoustic excitation. The ultrasound transducer was driven by a function generator (Keysight 33210A) and a RF power amplifier (Electronics & Innovation 1040L). Acoustic emissions from particles were detected using a passive cavitation detector (PCD, 15 MHz, Olympus, Japan VU-V319) co-axially aligned with the transducer.

The PCD signal was unfiltered, but all other experiments utilized an analogue 2.5 MHz high-pass filter (Allen Avionics F5286-2P50-B) before amplification through a broadband amplifier (5×, SRS SR445A). This processed signal was captured on the oscilloscope (National Instruments, USA PCI-5122) and saved for later processing.

The geometric focus of the transducer was 1.47 mm in width and 10.21 mm in length. All the experiments were carried out in a large tank filled with filtered degassed and deionised water.

The acoustic response of AuNCs was assessed at 1.1 MHz with 20 cycle bursts at a pressure ramp from 0.2 to 5.2 MPa.

The acoustic emissions (the recorded signal) were post processed by a power fast Fourier transform (FFT) to determine the power spectral density (PSD) curve. For each burst, the area under the PSD curve was determined and compared to degassed water exposed to ultrasound under the same conditions. Following the signal processing, cavitation was said to occur if the received signals were 6 dB higher than noise from the water control. The probability of cavitation was determined as the ratio of bursts that recorded a cavitation event out of the total number of ultrasound bursts. Acoustic amplitudes in this study are reported in MPa peak negative pressures.

To determine the PCD signal “energy” from the measured acoustic noise (henceforth referred to as cavitation energy) emitted from the sonochemical reactor during ultrasound exposure, we summed the area under the PSD curve of each burst.

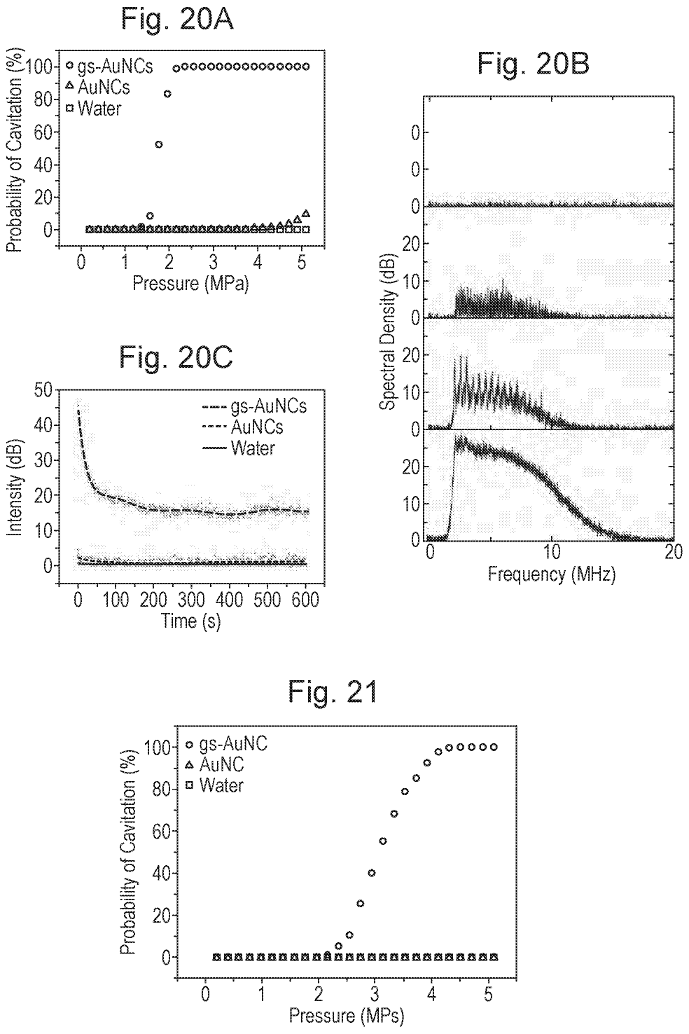

From these measurements, we calculated the probability for inertial cavitation and determined cavitation threshold (pressure at 50% cavitation) for 1 mg/ml of AuNCs (FIG. 20a). For gas-stabilized AuNCs, the cavitation threshold was found to be at 1.8 MPa. Comparatively, when AuNCs were degassed, the lack of bubble entrapment reduced the acoustic response of the particles to 4.5 MPa. These degassed AuNCs did demonstrate minimal presence of cavitation (probability <10%) at the maximum tested peak negative pressure amplitude of 5.2 MPa, must likely as a result of the AuNCs functioning as a local defect to the cavitation threshold of pure water, while gs-AuNCs more significantly reduced the cavitation threshold due to the presence of gas bubbles on the AuNCs surface. In the context of many industrial applications, inducing cavitation events in the fluid media requires much greater acoustic intensities that what was assessed here [9,26]. In contrast, gs-AuNCs displayed cavitation at peak negative pressure amplitudes of at least 1.3 MPa with the likelihood of cavitation monotonically increasing to 100% at 2.5 MPa. The inertial cavitation with gs-AuNCs is attributed to the gas trapped (within the cavity or on the surface) during drying and resuspension process [27]. Cavitation threshold for 0.1 mg/ml of gs-AuNCs was 3.1 MPa peak negative pressure (FIG. 21) and reached 100% of cavitation at 4.5 MPa. Interestingly, 0.1 mg/ml of AuNCs particles and deionized water did not respond cavitate at any pressure amplitude tested, emphasizing the importance of gas trapping on the nanocones.

Interestingly, the cavitation threshold of AuNCs was substantially smaller than other similarly sized nanoparticles [28]. This may be attributed to the geometry of the AuNCs [29]. Because of the conical shape of the AuNCs and relatively thin walls, most of the AuNCs is comprised of empty space. This empty space is able to accommodate a larger volume of gas compared to both mesoporous and shell-stabilized bubble systems [28,30-32]. Also, the trapped nanobubbles on the AuNCs are easily excitable due to the wide-opening of cone-shaped gold nanoparticles, thereby substantially reducing the inertial cavitation threshold. By investigating the frequency content of the acoustic response data in FIG. 2a, it was evident that there was a distinct change in intensity of the received signal from a cavitation event (FIG. 20b). Furthermore, this sudden signal was broadband dominant, which was a stark

contrast to microbubbles, but similar to other sub-micron systems [22]. We then measured cavitation intensity of gs-AuNCs across 10 minutes of HIFU exposure (1.1 MHz ultrasound at a pressure of 5 MPa pulsed at 2 Hz for 10 min). The results demonstrated sustained cavitation activity throughout the 10 min exposure with a sharp decay at the beginning (FIG. 20c).

We further validated the acoustic response of the gs-AuNCs at a range of concentrations of 0.01, 0.05, and 0.1 mg/ml (FIG. 22). At a lower concentration of 0.01 mg/ml, the cavitation was found unreliable (<5%). Comparatively, the gs-AuNCs at 0.05 mg/ml reached 50% of cavitation at 5.0 MPa and the cavitation threshold further reduced to 3.1 MPa peak negative pressure when increasing the concentration to 0.1 mg/ml. Given this, it is clear that cavitation response is proportional to the concentration of gs-AuNCs. In our study, we used 0.1 mg/ml gs-AuNCs as a baseline concentration and utilized a peak negative pressure of 5 MPa to ensure 100% cavitation throughout the irradiation period for all subsequent tested.

### Catalytic Study on 4-Nitrophenol and Methylene Blue

Once we validated the acoustic response of the AuNCs, we next set out to confirm their nonreactive potential by degradation of 4-nitrophenol and methylene blue. These model dyes were selected as Au catalyst-based reduction of 4-nitrophenol to 4-aminophenol [33,34], as well as the reduction of methylene blue to leucomethylene blue [33,35,36] in the presence of NaBH4 is well established [37,38]. Here, the Au acts as an electron relay system for transfer electron between the oxidant and reductant. Unfortunately, the catalytic efficiency for electron-transfer on a metallic nanoparticle is size dependent, resulting in a dramatically reduced redox potential with increasing size [40]. Also, the surface conversion of reactants is considered to be a rate limiting step in the catalytic process, where competition for catalytic surface sites via each competing reaction affects the overall reaction rate [41].

To overcome this limitation, we utilized a sonochemical approach to promote the catalytic activity of AuNCs at a sub-micron scale. The study shows that cavitation and its aforementioned effects co-localised with the catalytic surface will improve the catalytic reaction rates of Au under ambient conditions. Inertial cavitation from our gs-AuNCs serves two purposes. First, bubble collapse nucleated from gs-AuNCs directly converts water into hydroxyl radicals, hydrogen peroxide, and other ROS via pyrolysis. Second, thermal and mechanical effects from a collapsing bubble may improve the catalytic performance of gs-AuNCs.

4-nitrophenol (0.5 mL, 0.1 mM) was mixed with fresh NaBH4 solution (0.5 mL, 0.5 mM). For methylene blue degradation, 0.5 mL of 0.03 mM methylene blue solution was mixed with 0.5 mL of 0.05 mM fresh NaBH4 solution. Then 50 ul of 2 mg/ml of AuNCs resuspensions were added into the solutions. The reaction mixture was transferred into the static chamber for high intensity focused ultrasound exposure (1.1 MHz, 5 MPa). After irradiation, the solutions were collected from the reaction chamber and centrifuged at 9000 RCF for 5 minutes to pellet the nanoparticles. The rate of catalytic reaction was determined using UV-vis spectroscopy. The first order rate kinetics were calculated using a linear regression on the concentration change with time according to the equation

$$- ln ( \frac{{c}_{i}}{{c}_{0}} ) = kt ,$$

where Cᵢ is the concentration of dye at a given ultrasound exposure period, C₀ is the initial dye concentration at t=0 min and k is the first order rate kinetics.

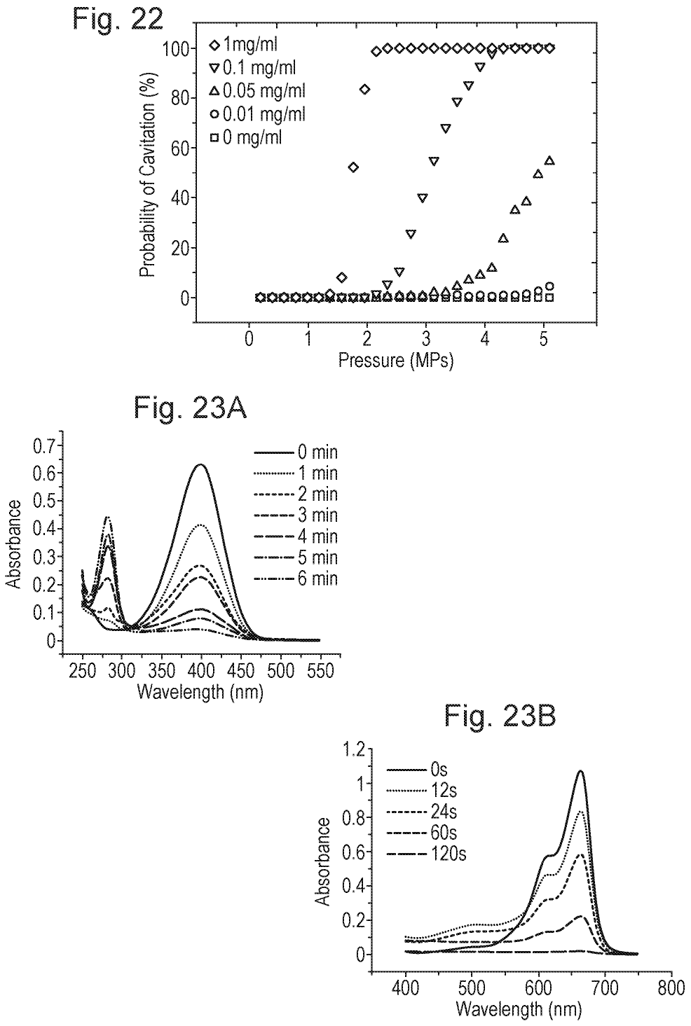

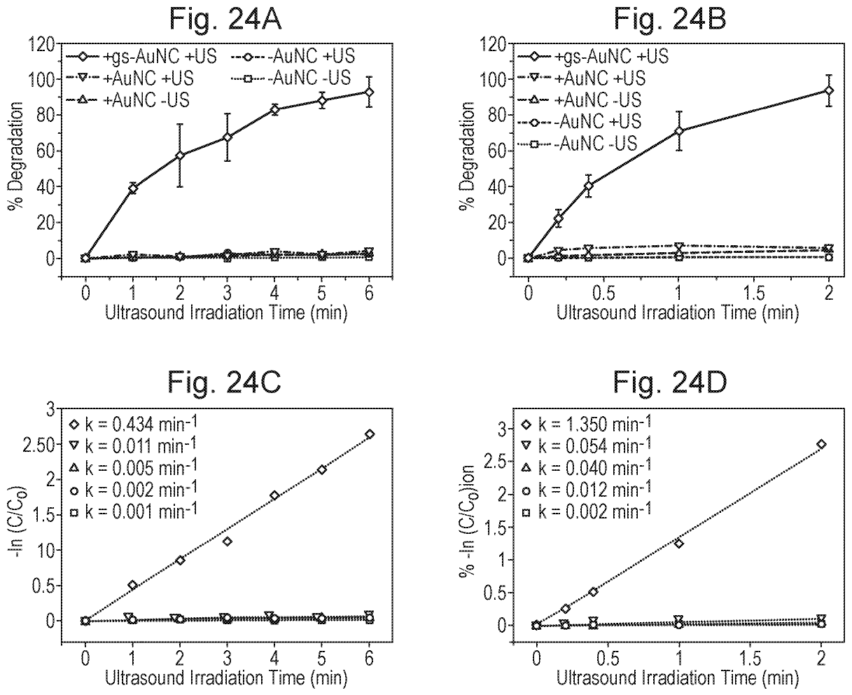

The dynamics of these samples was compared to the control samples in the absence of ultrasonic irradiation. The resulting degradation of 4-nitrophenol and methylene blue was quantified by UV-vis (FIG. 23) and visualized with respect to time in FIG. 24a and FIG. 24b.

Given that we utilized pulsed ultrasound, we defined ultrasound irradiation time as the total time the ultrasound transducer was active. Here, the ultrasound irradiation time was 20% of the total exposure time, i.e., the duty cycle was 20%. We found that degradation of 4-NP and MB was exhibited within 6 minutes and 2 minutes of ultrasound irradiation time, respectively. To validate that this enhancement was due to site-specific cavitation from gs-AuNCs, 4-NP and MB solutions with non-gas stabilised AuNCs were exposed to ultrasound under the same acoustic parameters. Without trapped gas, AuNCs exhibited fewer cavitation events during ultrasound irradiation (FIG. 20c) and subsequently resulted in less degradation of the dyes over the same time points for both 4-NP and MB, which are generally more similar to the AuNCs without ultrasound irritation (FIG. 24). In the absence of AuNCs, the degradation of 4-NP and MB solution proceeded very slowly with or without ultrasound irradiation.

Without AuNCs, 4-nitrophenol and methylene blue solutions expressed minimal degradation, irrespective of ultrasound irradiation. We observed that AuNCs without ultrasound passively decoloured the solutions, but the reaction rate was still relatively slow due to the high kinetic energy barrier[37], while ultrasonic irradiation of the solutions with AuNCs resulted in probe degradation exponentially. We assessed the rate kinetics of these reactions, where we calculated AuNCs without ultrasound to degrade the probes at rates of 0.005 min⁻¹ and 0.04 min⁻¹ for 4-nitrophenol (FIG. 24c) and methylene blue (FIG. 24c), respectively. In stark contrast, degradation of 4-nitriphenol and methylene blue increased by 87-fold to 0.43 min⁻¹ and 34-fold to 1.35 min⁻¹ respectively with gs-AuNCs under focused ultrasound irradiation compared to the no ultrasound group. These measurements suggested that localized cavitation events onto the catalyst played a vital role in the reaction.

In the present study, ultrasound assist process have shown to dramatically improve catalysis performance of AuNCs through acoustic cavitation. This high synergistic effect was due to thermal, mechanical, and chemical effect of cavitation nucleated from gas trapped in AuNCs [42]. This gas entrapment facilitated more efficient cavitation nucleation at the site of the catalyst, allowing for rapid and efficient physicochemical changing for the catalytic reactions. Ultrasound induced cavitation from AuNCs will result in local physicochemical changes (e.g. microstreaming, microjet, localized extreme temperatures, free radicals, and sonoluminescence) to the reaction environment under ambient conditions. Microstreaming and microjet increases the catalytic rate by favouring a high mass-transport rate, improving the adsorption and desorption process of reactant [41]. The collapse of bubble involved high microscopic temperature lower activation energy and improve the electron transfer rate, thus increasing the rate constant and the speed of the reaction [43]. AuNCs as sonosensitizer produce highly reactive free radicals from the pyrolysis of water[44]. 4-nitrophenol will be attacked by hydroxyl radicals and generates organic radicals or some other intermediates [45,46]. In methylene blue catalytic reaction, the hydroxyl racial react with methylene blue

cation to produce colourless methylene blue cation[47]. Moreover, the sonoluminescent-medicated SPR effect, a unique photophysical response of conduction electrons of metal nanoparticles with incident photons, induces a collective coherent oscillation of free electrons (conduction band electrons) in AuNCs that enhanced catalytic activity[48,49]. As a result, these effects will synergistically promote the catalysis of 4-nirophenol and methylene blue.

To validate that this enhancement was due to site-specific cavitation, non-gas stabilized AuNCs were irradiated with ultrasound in methylene blue and 4-nitrophenol solutions at the same ultrasound exposure conditions. Without gas-trapping, AuNCs exhibited fewer cavitation events during ultrasound irradiation (FIG. 20b) and subsequently resulted in less degradation of 4-nitrophenol and methylene blue over the same time points (0.011 min-1 and 0.054 min-1, respectively) compared to gs-AuNCs (FIG. 24). These measurements indicated cavitation play a vital role for AuNCs catalytic reactions.

Though ultrasound and cavitation have been studied for chemical processing[9,11,50,51], the intensity of inertial cavitation during sonochemistry is rarely quantified in current literature. Here, we evaluated how cavitation energy correlated to the sonodegradation of the probes.

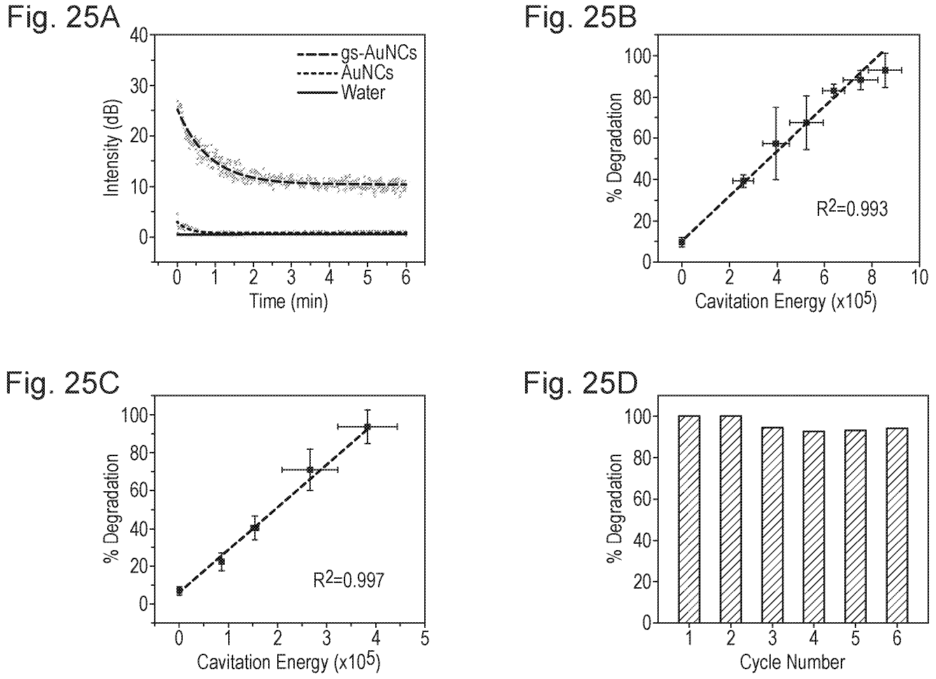

Specifically, we evaluated the correlation between the percentage of sonodegradation of the dyes at different ultrasound irradiation durations to the measured PCD signal energy, which is proportional to the cavitation energy across that duration. When normalizing this energy against a reference signal, we can further observe acoustic intensity of sonochemical reactor change over time (FIG. 25a). The results demonstrated gs-AuNCs sustained cavitation activity throughout the 6 min exposure with a decay at the beginning Similar to the behaviour presented in FIG. 20a, AuNCs presented virtually identical cavitation behaviour as water, further demonstrating that the presence of cavitation was due to the gas trapped by the gs-AuNCs. The recorded PCD signal energy proportional to inertial cavitation (referred to as cavitation energy here) from gs-AuNCs throughout the reaction were correlated to 4-NP and MB degradation (FIG. 25b and c). We observed a direct positive correlation between the cavitation response of the sonochemical reactor and degradation for both 4-NP (FIG. 25b) and MB (FIG. 25c). Given our findings in FIG. 24, whereby gs-AuNCs with ultrasound irradiation demonstrated an exponential change in 4-NP and MB degradation, it is evident that catalyst site-specific cavitation was critical for gs-AuNC-mediated sonocatalysis.

The rate kinetics were measured from total cavitation energy emitted by gs-AuNCs during catalysis at each of time points (FIG. 25). It can be observed that the degradation increased for both methylene blue and 4-nitriphenol with the increasing received cavitation energy, indicating a positive correlation between cavitation energy and catalytic reaction for both 4-nitrophenol and methylene blue (R2=0.993 and 0.997, respectively).

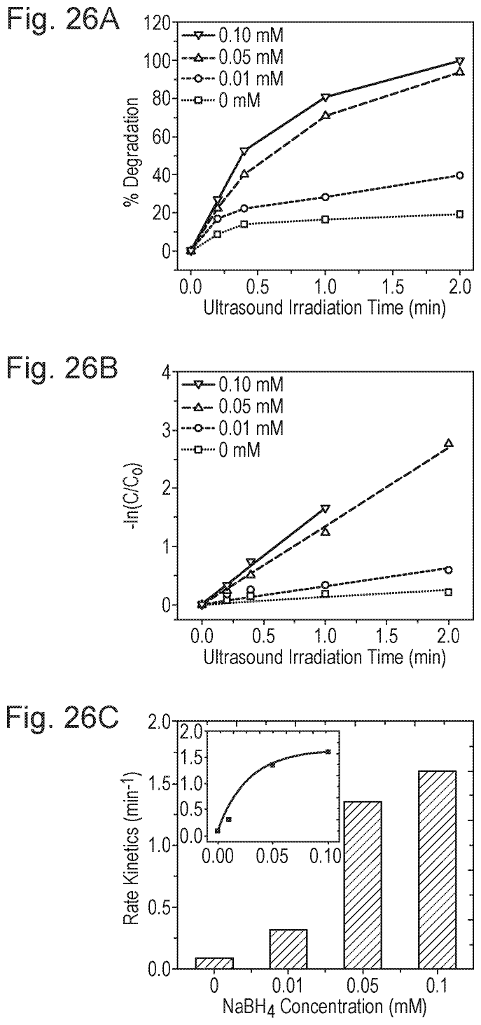

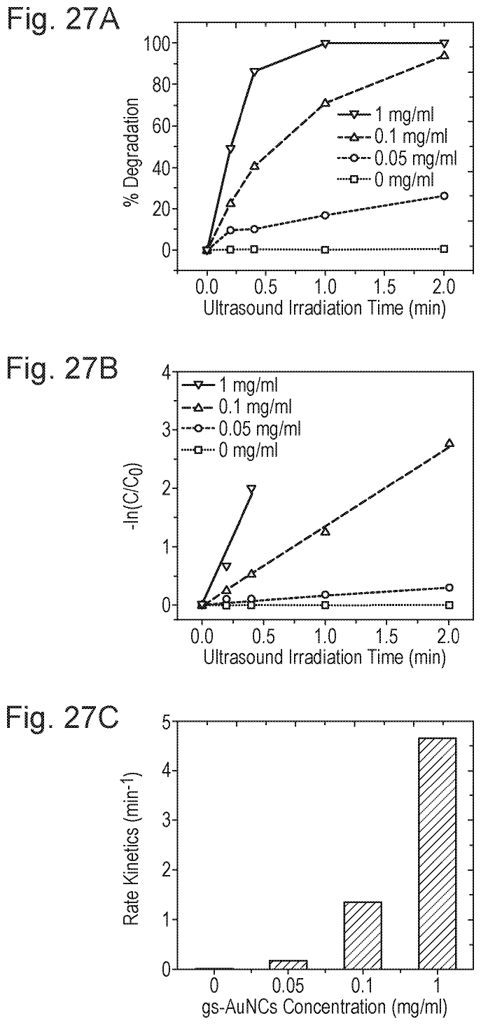

The effect of the dosage of NaBH4 and gs-AuNCs on the catalytic degradation of MB has also been evaluated. FIG. 26 shows the effect of NaBH4 concentration on the sonodegradation of MB by gs-AuNCs. The reaction rates of the sonocatalytic degradation of MB were significantly enhanced by increasing the dosage of NaBH4, and nearly complete degradation of MB was observed with 2 minutes of ultrasound irradiation at 0.05 and 0.1 mM. The rate for MB degradation increases from 0.09 min⁻¹ at 0 mM NaB_{H}4 to 1.35 at 0.05 mM NaBH₄ and then levels off to a plateau of 1.6 min⁻¹ at 0.1 mM NaBH₄. FIG. 27 shows the effect of gs-AuNCs concentration on the degradation efficiency of MB. The rate increases significantly from 0.16 min⁻¹ at 0.05 mg/ml gs-AuNCs to 4.66 min⁻¹ at 1 mg/ml gs-AuNCs. The increase in rate for MB degradation upon increasing concentration of gs-AuNCs is due to the increase reactive sites of Au and higher inertial cavitation generation during the sonochemical reactions.

The high catalytic activity of gs-AuNCs in the presence of ultrasound is evident by the results of the present work. Conventionally, gold nanoparticles are either in the size range of a few nanometers or is supported to obtain high catalytic activities (Table 1). Existing literature has shown that the catalytic activity reduces with increasing size of the gold particles [8]. In this study, submicron sized non-supported gold nanocones with a dendritic structure was reported as both cavitation nuclei and catalyst for fast organic pollute degradation. The nano-branched petals with long narrow gaps (1-2 nm) of AuNCs may attribute to the catalytic activity, presenting a comparable rate kinetics to existing Au catalysts with much smaller sizes under similar reaction conditions[3,8]. Most importantly, AuNCs are able to nucleate inertial cavitation in the catalyst site with ultrasound irradiation, which is dominant in the overall sonocatalytic reaction rate. This method of site-specific cavitation onto 160 nm gold nanocones enhanced the catalytic potential of the particles at rates of 200-fold higher than 55 nm spherical Au catalysis [8], and 27-fold higher than 8 nm spherical Au catalysis [8] and 9-fold higher than 14 nm supported heterogeneous Au catalysts[3]. Furthermore, our sonochemical approach contributes to the stability and dispersity of Au catalyst, where supported materials are not needed for the metal sonocatalyst design. The idea of using ultrasound and cavitation enhances the reactivity of catalytic agents, thereby providing the potential of improving the efficacy of various chemical reactions. By simple tuning the shape of current Au catalyst, Au cavitation agents can be developed to improve catalyst activity to a great extent. Our study provides a new approach to develop and optimise larger sound responsive metal sonocatalyst for high catalytic activities.

TABLE 1
Comparison of catalytic activity of Au by degradation of 4-nitrophenol

| | | | | Normalized rate | |
|---|---|---|---|---|---|
| | Au Size | Dose | Rate constant | constant (k, | |
| Catalysts | (nm) | (mg · mL⁻¹) | (k, min⁻¹) | min⁻¹ mg⁻¹) | Ref |
| Au + Ultrasound | 170 | 0.1 | 0.434 | 4.34 | This work |
| Au | 170 | 0.1 | 0.005 | 0.050 | This work |
| Au | 10 | — | 0.007 | — | [25] |
| Au/Resin | 8 | 2 | 0.016 | 0.008 | [8] |
| Au/Resin | 55 | 2 | 0.002 | 0.001 | [8] |
| Au/rGO | 3 | 1 | 0.215 | 0.215 | [26] |
| Au/CeO₂/rGO | 3 | 1 | 0.438 | 0.438 | [26] |
| Au@Ag@PDA/rGO | 14 | — | 0.050 | — | [2] |
| Au@Au@PDA/rGO | 14 | — | 0.020 | — | [2] |
| Au@g-C₃N₄ | 2.6 | 0.02 | 0.356 | 17.80 | [27] |

TABLE 2
Comparison of catalytic activity of Au by degradation of methylene blue

| | | | | Normalized | |
|---|---|---|---|---|---|
| | Au Size | Dose | Rate constant | rate constant | |
| Catalysts | (nm) | (mg · mL⁻¹) | (k, min⁻¹) | (k, min⁻¹mg⁻¹) | Ref |
| Au + Ultrasound | 170 | 0.1 | 1.35 | 13.50 | This work |
| Au | 170 | 0.1 | 0.04 | 0.40 | This work |
| Au/Zeolite | 6 | 5 | 0.07 | 0.012 | [28] |
| Au@TiO₂ | 2-5 | 0.1 | 0.156 | 1.56 | [29] |
| Au@polypyrrole/Fe₃O₄ | 15 | 0.57 | 0.266 | 0.466 | [30] |
| Au/ZnO—CeO₂ | 30-40 | 0.02 | 0.552 | 27.60 | [31] |

Proposed Mechanism for gs-AuNC Derived Sonocatalysis

In this study, we demonstrate how co-localisation of the cavitation events onto the catalyst dramatically improves the catalytic performance of gs-AuNCs. This faster catalytic sonochemistry may be due to thermal, mechanical, and chemical effects of cavitation nucleated from gas trapped in AuNCs. By stabilizing gas onto the Au cavities, cavitation events more readily nucleate at the catalytic site; the bubble is the primary defect that enables cavitation and it has been shown that cavitation from gas-stabilising solids occurs at the nanoparticle. As a result, there will exist a temporary and localised high-energy microenvironment primed for catalytic reactions under bulk ambient conditions.

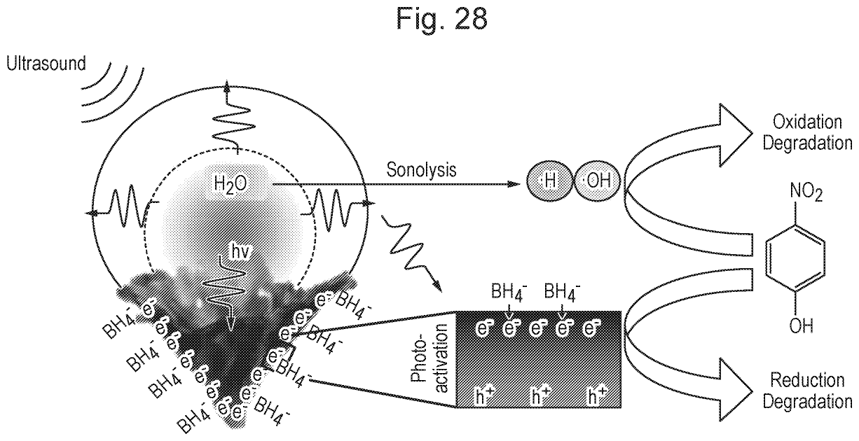

Within this cavitation-induced high-energy microenvironment, there is a multitude of physical and chemical effects occurring in parallel that may enhance catalysis (FIG. 28). For 4-NP and MB reactions, the reactant ions and a hydrogen species derived from BH₄⁻ first adsorb onto the surface of the catalyst. A reduction reaction then occurs via electron transfer from the donor BH₄⁻ to the acceptor reactants on the surface of Au catalyst. Microstreaming and microjetting from collapsing bubbles increase the catalytic rate by favouring a high mass-transport rate, improving the adsorption and desorption process of the reactants. As a cavitation bubble inertially collapses, the gas and vapour trapped in the bubble becomes extremely hot and pressurised pyrolyzing molecules into free radicals (sonolysis). The catalytic reaction rate may be increased at these higher temperatures due to the reduction in reaction activation energy and improved electron transfer rate. Furthermore, sonoluminescence from bubble collapse may also occur and mediate photoactivation of AuNCs. This photophysical response of conduction electrons in metal nanoparticles to incident photons induces a collective coherent oscillation of free electrons (conduction band electrons) in AuNCs that enhances catalytic activity. For the reactions studied here, 4-NP may have been hydrogenated to form 4-aminophenol by way of mechanical-, thermal-, and photo-activation, or have been attacked by hydroxyl radicals to generate organic radicals or some other intermediates. Similarly, electrons and hydroxyl radicals were likely the main species to decolour the MB solution. Electrons may convert MB to the colourless leucomethylene blue. Free radical species may react with the MB cation break down the molecule and form a wide range of degradation intermediates that may be further decomposed and mineralized into CO₂, H₂O, SO₄²⁻ and NO₃⁻. Our approach demonstrated that control of cavitation at catalytic sites by structuring the catalyst to trap gas (gs-AuNCs) provided rapid degradation of pollutants. Though only 4-NP and MB were studied in this report as a proof-of-concept, it is important to emphasize that this method to couple cavitation events and catalysts may be a simple strategy to improve the efficacy of metal catalysts for other advanced catalytic processes.

### Conclusion

In summary, we manufactured ultrasound-responsive gold nanocones for efficient, green sonochemical processing. AuNCs were investigated for their potential to nucleate cavitation and enhance sonocatalytic degradation of both MB and 4-nitrophenol. Our results indicated that the gas trapping cavity of the Au catalyst enabled more effective catalytic sonochemistry. By trapping gas onto the AuNCs, the particles nucleated inertial cavitation at the site of the catalyst at relatively low acoustic pressures change the local physicochemical environment to create a high-energy microreactor primed for the catalytic reactions. This resulted in catalytic reaction rates at least one order of magnitude faster than existing literature using comparable Au sizes. Furthermore, the cavitation energy from gs-AuNCs indicated a direct positive correlation to chemical degradation, validating the importance of cavitation events and colocalization of the events to photocatalytic sites. In short, we showed that simple structuring of the shape of Au catalysts will greatly improve the catalyst reaction rates. The idea of using catalysts as cavitation nuclei to enhance the reactivity of the catalytic agents is not limited to the examples provided in this report, and therefore suggests that this approach may be a simple strategy to improve the efficacy of other catalytic sonochemical reactions.

### Commercial Applications of the Invention

In the proof-of-concept data provided above, it has been demonstrated that ultrasonic irradiation of our cavitation agents facilitated rapid decolorization of methylene blue from liquid media. Methylene blue is one of many common dyes produced by the textile industry and its efficient removal from wastewater is an ongoing problem in sustainable engineering. It has additionally been demonstrated that the nucleation cavitation at Au catalytic site assisted more effective sonocatalytic process.

Given the propensity of these particles to generate free radicals on ultrasound irradiation, this invention has use in a broad spectrum of industries where catalytic reactions are required for sustainable chemical processing. Below is a list of some select applications:
Wastewater Treatment
Catalytic oxidation of intermediates for pharmacologic precursors (e.g. benzaldehyde conversion from benzyl alcohol)
Catalysis for controlled radical polymerization
Embolytic therapy (gel formation to block vasculature)
Advanced oxidation processes
Selective oxidation
C1 and C2 chemistry
Hydrogen production
Ammonia chemistry

### REFERENCES

References in square brackets:
[1 ] Z. W. Seh, S. Liu, M. Low, S. Y. Zhang, Z. Liu, A. Mlayah, M. Y. Han, Janus Au-TiO 2 photocatalysts with strong localization of plasmonic near-fields for efficient visible-light hydrogen generation, Adv. Mater., 24 (2012) 2310-2314.
[2] J. Zhou, B. Duan, Z. Fang, J. Song, C. Wang, P. B. Messersmith, H. Duan, Interfacial assembly of mussel-inspired au@ag@ polydopamine core-shell nanoparticles for recyclable nanocatalysts, Adv. Mater., 26 (2014) 701-705.
[3] A. Alshammari, V. N. Kalevaru, Supported Gold Nanoparticles as Promising Catalysts, InTech2016, pp. 425-449.
[4] M. M. Schubert, S. Hackenberg, A. C. Van Veen, M. Muhler, V. Plzak, J. J. Behm, CO oxidation over supported gold catalysts—“Inert” and “active” support materials and their role for the oxygen supply during reaction, J. Catal., 197 (2001) 113-122.
[5] T. Ishida, T. Murayama, A. Taketoshi, M. Haruta, Importance of Size and Contact Structure of Gold Nanoparticles for the Genesis of Unique Catalytic Processes, Chem. Rev., 120 (2020) 464-525.
[6] S. Praharaj, S. Nath, S. K. Ghosh, S. Kundu, T. Pal, Immobilization and recovery of Au nanoparticles from anion exchange resin: Resin-bound nanoparticle matrix as a catalyst for the reduction of 4-nitrophenol, Langmuir, (2004).
[7] M. D. Argyle, C. H. Bartholomew, Heterogeneous catalyst deactivation and regeneration: A review, 2015.
[8] S. Panigrahi, S. Basu, S. Praharaj, S. Pande, S. Jana, A. Pal, S. K. Ghosh, T. Pal, Synthesis and size-selective catalysis by supported gold nanoparticles: Study on heterogeneous and homogeneous catalytic process, Journal of Physical Chemistry C, 111 (2007) 4596-4605.
[9] N. Saadah, M. Yusof, B. Babgi, Y. Alghamdi, M. Aksu, J. Madhavan, Ultrasonics Sonochemistry Physical and chemical effects of acoustic cavitation in selected ultrasonic cleaning applications, Ultrasonics—Sonochemistry, 29 (2016) 568-576.
[10] R. J. Wood, J. Lee, M. J. Bussemaker, A parametric review of sonochemistry: Control and augmentation of sonochemical activity in aqueous solutions, Ultrason. Sonochem., 38 (2017) 351-370.
[11] T. G. McKenzie, F. Karimi, M. Ashokkumar, G. G. Qiao, Ultrasound and Sonochemistry for Radical Polymerization: Sound Synthesis, Chemistry, 25 (2019) 5372-5388.
[12] K. S. Suslick, G. J. Price, Applications of Ultrasound to Materials Chemistry, Annu. Rev. Mater. Sci., 29 (1999) 295-326.
[13] K. S. Suslick, Sonochemistry, Science, 247 (1990) 1439-1445.
[14] K. S. Suslick, The sonochemical hot spot, The Journal of the Acoustical Society of America, 89 (1991) 1885-1886.
[15] S. S. Rekhviashvili, Single-bubble sonoluminescence model, Technical Physics Letters, 34 (2008) 1072-1074.
[16] J. González-Garcia, V. Sáez, I. Tudela, M. I. Díez-Garcia, M. Deseada Esclapez, 0. Louisnard, Sonochemical Treatment of Water Polluted by Chlorinated Organocompounds. A Review, Water, 2 (2010) 28-74.
[17] I. Lentacker, I. De Cock, R. Deckers, S. C. De Smedt, C. T. W. Moonen, Understanding ultrasound induced sonoporation: Definitions and underlying mechanisms, Adv. Drug Del. Rev., 72 (2014) 49-64.
[18] H. B. Briggs, J. B. Johnson, W. P. Mason, Properties of Liquids at High Sound Pressure, J. Acoust. Soc. Am., 19 (1947) 664-677.
[19] G. ter Haar, Therapeutic applications of ultrasound, Prog. Biophys. Mol. Biol., 93 (2007) 111-129.
[20] J. J. Kwan, S. Graham, R. Myers, R. Carlisle, E. Stride, C. C. Coussios, Ultrasound-induced inertial cavitation from gas-stabilizing nanoparticles, Physical Review E—Statistical, Nonlinear, and Soft Matter Physics, 92 (2015) 1-5.
[21] Q. Jin, S.-t. Kang, Y.-c. Chang, H. Zheng, C.-k. Yeh, Inertial Cavitation Initiated by Polytetrafluoroethylene Nanoparticles under Pulsed Ultrasound Stimulation, Elsevier B.V.2016.
[22] J. L. Paris, C. Mannaris, M. V. Cabañas, R. Carlisle, M. Manzano, M. Vallet-Regi, C. C. Coussios, Ultrasound-Mediated Cavitation-Enhanced Extravasation of Mesoporous Silica Nanoparticles for Controlled-Release Drug Delivery, Chem. Eng. J., 340 (2017) 2-8.
[23] C. Mannaris, B. M. Teo, A. Seth, L. Bau, C. Coussios, E. Stride, Gas-Stabilizing Gold Nanocones for Acoustically Mediated Drug Delivery, Adv Healthc Mater, 7 (2018) e1800184.
[24] E. Beguin, S. Shrivastava, N. V. Dezhkunov, A. P. McHale, J. F. Callan, E. Stride, Direct Evidence of Multibubble Sonoluminescence Using Therapeutic Ultrasound and Microbubbles, ACS Appl Mater Interfaces, 11 (2019) 19913-19919.
[25] S. R. Thawarkar, B. Thombare, B. S. Munde, N. D. Khupse, Kinetic investigation for the catalytic reduction of nitrophenol using ionic liquid stabilized gold nanoparticles, RSC Adv., 8 (2018) 38384-38390.
[26] Z. Ji, X. Shen, Y. Xu, G. Zhu, K. Chen, Anchoring noble metal nanoparticles on CeO2 modified reduced graphene oxide nanosheets and their enhanced catalytic properties, J. Colloid Interface Sci., 432 (2014) 57-64.
[27] Y. Fu, T. Huang, B. Jia, J. Zhu, X. Wang, Reduction of nitrophenols to aminophenols under concerted catalysis by Au/g-C3N4 contact system, Applied Catalysis B: Environmental, 202 (2017) 430-437.
[28] E. R. León, E. L. Rodríguez, C. R. Beas, G. Plascencia-Villa, R. A. I. Palomares, Study of Methylene Blue Degradation by Gold Nanoparticles Synthesized within Natural Zeolites, Journal of Nanomaterials, 2016 (2016).
[29] W. Li, J. Liu, D. Zhao, Mesoporous materials for energy conversion and storage devices, Nature Reviews Materials, (2016) 16023-16023.
[30] T. Yao, T. Cui, H. Wang, L. Xu, F. Cui, J. Wu, A simple way to prepare Augpolypyrrole/Fe3O4 hollow capsules with high stability and their application in catalytic reduction of methylene blue dye, Nanoscale, 6 (2014) 7666-7674.
[31] Y.-F. Zhou, High intensity focused ultrasound in clinical tumor ablation, World Journal of Clinical Oncology, 2 (2011) 8-8.

References in curved brackets:
1. K. S. Suslick, G. J. Price, Applications of Ultrasound to Materials Chemistry. Annu. Rev. Mater. Sci. 29, 295-326 (1999).
2. T. G. McKenzie, F. Karimi, M. Ashokkumar, G. G. Qiao, Ultrasound and Sonochemistry for Radical Polymerization: Sound Synthesis. Chemistry 25, 5372-5388 (2019).
3. R. G. Thomas, U. S. Jonnalagadda, J. J. Kwan, Biomedical Applications for Gas-Stabilizing Solid Cavitation Agents. Langmuir 35, 10106-10115 (2019).
4. R. J. Wood, J. Lee, M. J. Bussemaker, A parametric review of sonochemistry: Control and augmentation of sonochemical activity in aqueous solutions. Ultrason. Sonochem. 38, 351-370 (2017).
5. J. Bogdan, J. Plawinska-Czarnak, J. Zarzynska, Nanoparticles of Titanium and Zinc Oxides as Novel Agents in Tumor Treatment: a Review. Nanoscale Res Lett 12, 225 (2017).
6. K. S. Suslick, J. R. BlakePerutz, Y. Didenko, M. M. Fang, T. Hyeon, K. J. Kolbeck, W. B. McNamara, M. M. Mdleleni, M. Wong, Acoustic cavitation and its chemical consequences. Philosophical Transactions of the Royal Society of London. Series A: Mathematical, Physical and Engineering Sciences 357, 335-353 (1999).
7. H. Xu, B. W. Zeiger, K. S. Suslick, Sonochemical synthesis of nanomaterials. Chem. Soc. Rev. 42, 2555-2567 (2013).
8. J. Collins, T. G. McKenzie, M. D. Nothling, M. Ashokkumar, G. G. Qiao, High frequency sonoATRP of 2-hydroxyethyl acrylate in an aqueous medium. Polym. Chem. 9, 2562-2568 (2018).
9. L. Parizot, T. Chave, M.-E. Galvez, H. Dutilleul, P. Da Costa, S. I. Nikitenko, Sonocatalytic oxidation of EDTA in aqueous solutions over noble metal-free Co3O4/TiO2 catalyst. Applied Catalysis B: Environmental 241, 570-577 (2019).
10. Y. He, J. Wan, Y. Yang, P. Yuan, C. Yang, Z. Wang, L. Zhang, Multifunctional Polypyrrole-Coated Mesoporous TiO2 Nanocomposites for Photothermal, Sonodynamic, and Chemotherapeutic Treatments and Dual-Modal Ultrasound/Photoacoustic Imaging of Tumors. Adv Healthc Mater 8, e1801254 (2019).
11. X. Wang, X. Zhong, L. Bai, J. Xu, F. Gong, Z. Dong, Z. Yang, Z. Zeng, Z. Liu, L. Cheng, Ultrafine Titanium Monoxide (TiO1+x) Nanorods for Enhanced Sonodynamic Therapy. J. Am. Chem. Soc. 142, 6527-6537 (2020).
12. X. Zhong, M. Zhang, Z. Tian, Q. Wang, Z. Wang, The Study of Enhanced High-Intensity Focused Ultrasound Therapy by Sonodynamic N2O Microbubbles. Nanoscale Res Lett 14, 381 (2019).
13. M. A. Beckett, I. Hua, Impact of Ultrasonic Frequency on Aqueous Sonoluminescence and Sonochemistry. The Journal of Physical Chemistry A 105, 3796-3802 (2001).
14. J. Wang, Y. Guo, B. Liu, X. Jin, L. Liu, R. Xu, Y. Kong, B. Wang, Detection and analysis of reactive oxygen species (ROS) generated by nano-sized TiO2 powder under ultrasonic irradiation and application in sonocatalytic degradation of organic dyes. Ultrason. Sonochem. 18, 177-183 (2011).
15. D. G. You, V. G. Deepagan, W. Um, S. Jeon, S. Son, H. Chang, H. I. Yoon, Y. W. Cho, M. Swierczewska, S. Lee, M. G. Pomper, I. C. Kwon, K. Kim, J. H. Park, ROS-generating TiO2 nanoparticles for non-invasive sonodynamic therapy of cancer. Sci Rep 6, 23200 (2016).
16. J. Lu, P. Zhang, A. Li, F. Su, T. Wang, Y. Liu, J. Gong, Mesoporous anatase TiO2 nanocups with plasmonic metal decoration for highly active visible-light photocatalysis. Chem Commun (Camb) 49, 5817-5819 (2013).
17. K. Zhang, F. J. Zhang, M. L. Chen, W. C. Oh, Comparison of catalytic activities for photocatalytic and sonocatalytic degradation of methylene blue in present of anatase TiO2-CNT catalysts. Ultrason. Sonochem. 18, 765-772 (2011).
18. J.-Y. Jung, D. Lee, Y.-S. Lee, CNT-embedded hollow TiO2 nanofibers with high adsorption and photocatalytic activity under UV irradiation. J. Alloys Compd. 622, 651-656 (2015).
19. R. S. Dariani, A. Esmaeili, A. Mortezaali, S. Dehghanpour, Photocatalytic reaction and degradation of methylene blue on TiO2 nano-sized particles. Optik 127, 7143-7154 (2016).
20. B. K. Mutuma, G. N. Shao, W. D. Kim, H. T. Kim, Sol-gel synthesis of mesoporous anatase-brookite and anatase-brookite-rutile TiO2 nanoparticles and their photocatalytic properties. J. Colloid Interface Sci. 442, 1-7 (2015).
21. E. Thasirisap, N. Vittayakorn, P. Seeharaj, Surface modification of TiO2 particles with the sono-assisted exfoliation method. Ultrason. Sonochem. 39, 733-740 (2017).
22. S. Sajjadi, A. Khataee, M. Kamali, Sonocatalytic degradation of methylene blue by a novel graphene quantum dots anchored CdSe nanocatalyst. Ultrason. Sonochem. 39, 676-685 (2017).
23. C. H. Nguyen, R.-S. Juang, Efficient removal of methylene blue dye by a hybrid adsorption—photocatalysis process using reduced graphene oxide/titanate nanotube composites for water reuse. Journal of Industrial and Engineering Chemistry 76, 296-309 (2019).
24. E. Beguin, S. Shrivastava, N. V. Dezhkunov, A. P. McHale, J. F. Callan, E. Stride, Direct Evidence of Multibubble Sonoluminescence Using Therapeutic Ultrasound and Microbubbles. ACS Appl Mater Interfaces 11, 19913-19919 (2019).
25. M. A. Margulis, I. M. Margulis, Contemporary review on nature of sonoluminescence and sonochemical reactions. Ultrason. Sonochem. 9, 1-10 (2002).
26. Y. L. Pang, S. Lim, R. K. L. Lee, Enhancement of sonocatalytic degradation of organic dye by using titanium dioxide (TiO2)/activated carbon (AC) derived from oil palm empty fruit bunch. Environ Sci Pollut Res Int 27, 34638-34652 (2020).
27. S. Liang, X. Deng, G. Xu, X. Xiao, M. Wang, X. Guo, P. a. Ma, Z. Cheng, D. Zhang, J. Lin, A Novel Pt—TiO2 Heterostructure with Oxygen-Deficient Layer as Bilaterally Enhanced Sonosensitizer for Synergistic Chemo-Sonodynamic Cancer Therapy. Adv. Funct. Mater. 30, (2020).
28. E. Alves Nunes Simonetti, L. D. S. Cividanes, T. M. Bastos Campos, F. Williams Fernandes, J. P. B. Machado, G. P. Thim, Sonocatalytic Degradation of Methylene Blue in the Presence of TiO2 Doped Carbon Nanostructures—Catalytic and Adsorption Comparison by Different Carbon Forms. Fullerenes, Nanotubes and Carbon Nanostructures 23, 725-733 (2015).
29. N. Shimizu, C. Ogino, M. F. Dadjour, T. Murata, Sonocatalytic degradation of methylene blue with TiO2 pellets in water. Ultrason. Sonochem. 14, 184-190 (2007).
30. R. Balakumara, K. Sathya, R. Saravanathamizhan, Decolorization of Methylene Blue Dye Using Sonocatalytic Followed by Photocatalytic Process. Water Conservation Science and Engineering 1, 161-166 (2016).
31. B. Boyd, S. A. Suslov, S. Becker, A. D. Greentree, I. S. Maksymov, Beamed UV sonoluminescence by aspherical air bubble collapse near liquid-metal microparticles. Sci Rep 10, 1501 (2020).
32. M. P. Brenner, S. Hilgenfeldt, D. Lohse, Single-bubble sonoluminescence. Rev. Mod. Phys. 74, 425-484 (2002).
33. J. Wang, J. Yu, X. Zhu, X. Z. Kong, Preparation of hollow TiO2 nanoparticles through TiO2 deposition on polystyrene latex particles and characterizations of their structure and photocatalytic activity. Nanoscale Res Lett 7, 646 (2012).
34. C. J. Howard, T. M. Sabine, F. Dickson, Structural and thermal parameters for rutile and anatase. Acta Crystallographica Section B Structural Science 47, 462-468 (1991).
35. J. J. Kwan, R. Myers, C. M. Coviello, S. M. Graham, A. R. Shah, E. Stride, R. C. Carlisle, C. C. Coussios, Ultrasound-Propelled Nanocups for Drug Delivery. Small 11, 5305-5314 (2015).
36. X. Su, R. G. Thomas, L. D. Bharatula, J. J. Kwan, Remote targeted implantation of sound-sensitive biodegradable multi-cavity microparticles with focused ultrasound. Scientific Reports 9, (2019).
37. U. S. Jonnalagadda, T. M. Nguyen, F. Li, J. H. C. Lee, X. Liu, A. Goto, J. J. Kwan, Sol-Gel Transitions of Comb-Like Polymethacrylate Copolymers by Mechano-Thermal Stimuli in Water. Macromol. Chem. Phys. 221, (2020).
38. H. N. Chang, S. X. Hou, Z. C. Hao, G. H. Cui, Ultrasonic green synthesis of an Ag/CP nanocomposite for enhanced photodegradation effectiveness. Ultrason. Sonochem. 40, 1039-1048 (2018).
39. C. J. Wrasman, A. Boubnov, A. R. Riscoe, A. S. Hoffman, S. R. Bare, M. Cargnello, Synthesis of Colloidal Pd/Au Dilute Alloy Nanocrystals and Their Potential for Selective Catalytic Oxidations. J. Am. Chem. Soc. 140, 12930-12939 (2018).

1. A sonocatalyst, comprising a nanoparticle which has a structure capable of trapping gas and which functions as a catalyst.

2. The sonocatalyst according to claim 1 wherein the nanoparticle comprises one or more cavities.

3. The sonocatalyst according to claim 1 wherein the nanoparticle comprises a fractured nanoshell structure, or a dendritic structure.

4. (canceled)

5. The sonocatalyst according to any preceding claim wherein the nanoparticle has a maximum diameter of 1 micron, preferably a maximum diameter of from 50 nm to 500 nm, more preferably from 100 nm to 300 nm; and/or wherein the nanocatalyst is capable of generating reactive oxygen species and/or radical species upon excitation, optionally excitation by exposure to ultrasound at frequencies in the range of above 100 kHz up to 500 kHz.

6. (canceled)

7. The sonocatalyst according to claim 1 wherein the nanoparticle comprises a catalytic material which is an electrochemical catalyst or a photocatalyst.

8. (canceled)

9. The sonocatalyst according to claim 1 wherein the nanoparticle comprises a catalytic material having an electron-hole pair which can be excited by electromagnetic radiation having a wavelength in the range 10 nm to 1400, optionally 10 nm to 700 nm.

10. The sonocatalyst according to claim 8 which comprises a photocatalyst, wherein the photocatalyst promotes the formation of radical species and/or reactive oxygen species, optionally radical reactive oxygen species.

11. The sonocatalyst according to claim 1 wherein the nanoparticle comprises a catalytic material which is selected from:
(a) a metal oxide or metal sulphide or metal nitride;
(b) a titanium oxide, a strontium oxide, a zirconium oxide, a tantalum oxide, a Niobium oxide, a tungsten oxide, or a zinc oxide;
(c) TiO₂ or FeTiO₂;
(d) SiO₂ or SrTiO₃;
(e) ZrO₂;
(f) TaO₂;
(g) K₄Nb₆O₁₇;
(h) WO₃;
(i) ZnO;
(i) a metal; or
(j) gold.

12-13. (canceled)

14. The sonocatalyst according to claim 1, wherein the nanoparticle comprises a dendritic gold structure containing a plurality of dendrites wherein each dendrite has a smallest dimension of 10 nm or less; optionally wherein the dendrites are arranged to form a nanocone structure.

15. The sonocatalyst according to claim 1 wherein the nanoparticle comprises two or more catalytic materials.

16. The sonocatalyst according to claim 1 wherein the nanoparticle is a submicron-sized solid particle with a surface cavity laden shell structure capable of trapping gas; which particle is capable of generating multiple reactive species upon exposure to ultrasound at frequencies above 100 kHz.

17. The sonocatalyst according to claim 1 which comprises a plurality of nanoparticles according to any of claim 1.

18. A method of catalysing a chemical reaction, the method comprising:
(i) providing a sonocatalyst; and
(ii) exposing the sonocatalyst to ultrasound.
wherein the sonocatalyst is as defined in claim 1.

19. The method according to claim 18 wherein the ultrasound causes a gas bubble trapped by the nanoparticle to undergo inertial cavitation, optionally generating reactive chemical species at the locus of the nanoparticle.

20. The method according to claim 18 wherein:
(i) step (i) additionally comprises contacting the sonocatalyst with a chemical reagent; and/or
(ii) step (ii) also comprises exposing the sonocatalyst to UV light and/or visable light.

21. The method according to claim 18 wherein the ultrasound is pulsed ultrasound, optionally pulsed focussed ultrasound.

22. The method according to claim 18 wherein the ultrasound frequency is greater than 100 kHz, optionally from 200 kHz to 500 kHz.

23. (canceled)

24. The method according to claim 18 which comprises using the sonocatalyst to catalyse the chemical reaction.

25. An apparatus for catalysing a chemical reaction, the apparatus comprising an ultrasound waveform generator and a sonocatalyst as defined in claim 1.

26. The method according to claim 18, which method comprises
a) providing a gold nanocone and at least one reactant in a liquid medium to form a mixture; and
b) subjecting the mixture to ultrasonic irradiation to activate the chemical reaction, optionally wherein the ultrasonic irradiation comprises a frequency of at least 100 kHz.
